(19) United States
(12) Patent Application Publication
(10) Pub. No.: US 2025/0111021 A1
(43) Pub. Date: Apr. 3, 2025

(54) DYNAMICALLY TRUSTED ENDPOINTS

(71) Applicant: Vercrio, Inc., Wilmington, DE (US)

(72) Inventors: Anthony Rajakumar, Fremont, CA (US); John Patrick Lockie, Valencia, CA (US)

(73) Assignee: Vercrio, Inc., Wilmington, DE (US)

(21) Appl. No.: 18/902,675

(22) Filed: Sep. 30, 2024

Related U.S. Application Data
(60) Provisional application No. 63/587,412, filed on Oct. 2, 2023.

(51) Int. Cl. G06F 21/31; G06F 21/56

(52) U.S. Cl. CPC G06F 21/31; G06F 21/56; G06F 2221/034

(57) ABSTRACT

An authentication server verifies the initiating device of a request for authentication is a trusted endpoint prior to proceeding with the authentication process to prevent an Adversary in the Middle (AiTM) attack on a deployed Multi-Factor Authentication (MFA) system. The server may verify that the initiating device is a trusted endpoint based on matching Internet Protocol (IP) addresses for the initiating device and a confirming device associated with an authorized user or by verifying the identity of the user based on video of the user captured by the initiating device. Verification that the initiating device is a trusted endpoint may be performed prior to sending a request for confirmation of the requestion for authentication to the confirming device or may be used to establish trust before issuing or updating a certificate to the initiating device for a certificate based authentication procedure.

### CROSS REFERENCE TO RELATED APPLICATIONS

This application claims priority under 35 USC § 119 to U.S. Provisional Application No. 63/587,412, filed Oct. 2, 2023, entitled “DYNAMICALLY TRUSTED ENDPOINTS,” which is incorporated by reference herein in its entirety.

### BACKGROUND

The use of multiple factors to authenticate a user's access to computer resources, commonly known as Multi-factor Authentication (MFA), has become widespread. Phone-based authentication applications, e.g., apps, such as Duo or Microsoft Authenticator, for example, are often used as part of an MFA system. In such an MFA system, the first factor is often a password and the second factor is a notification triggered to the authentication app on the user's phone, to which the user must respond affirmatively in order for the system to grant access. Thus, the authentication is a two-step process: the user enters their password into a web page, and if it matches, the system sends a push notification to the authentication app. If the user responds affirmatively to this notification on the user's phone, then access is granted.

Attackers have formulated a new method to compromise these systems and gain unauthorized access. The first step involves the compromise of passwords (through phishing, for example). Once they have acquired the password, they can circumvent the authentication app in multiple ways. One way in which an attacker may attempt to compromise a system after the password has been acquired, is through the authorization of a new phone using stolen information. Another way in which an attacker may attempt to compromise a system after the password has been acquired is through repeatedly triggering authentication attempts. Another way in which an attacker may attempt to compromise a system, once the password has been acquired, is through Adversary-In-The-Middle attacks.

### SUMMARY

An automated process for preventing an Adversary in the Middle (AiTM) attack on a deployed Multi-Factor Authentication (MFA) system uses an authentication server that verifies the initiating device of a request for authentication is a trusted endpoint prior to proceeding with the authentication process. In one implementation, the server may verify that the initiating device is a trusted endpoint based on matching Internet Protocol (IP) addresses for the initiating device and a confirming device associated with an authorized user. In one implementation, the server may verify that the initiating device is a trusted endpoint based on video verification of the identity of the user from video captured by the initiating device. The verification that the initiating device is a trusted endpoint may be performed prior to sending a request for confirmation of the request for authentication to the confirming device. In some implementations, additional security measures may be used, such as the use of a certificate based authentication procedure. In some implementations, verification that the initiating device is a trusted endpoint may be performed before issuing or updating a certificate to the initiating device.

In one implementation, a method for preventing an Adversary in the Middle (AiTM) attack on deployed Multi-Factor Authentication (MFA) system includes collecting Internet Protocol (IP) addresses for electronic devices associated with a plurality of users and store the IP addresses in a database. A request for authentication is received for a user from a first electronic device and the IP addresses associated with first electronic device is acquired. The method includes determining whether the IP address associated with the first electronic device matches an IP address associated with an electronic device associated with the user from the database, and proceeding with an authentication process for the user in response to a match between the IP address associated with the first electronic device and the IP address associated with the electronic device associated with the user from the database.

In one implementation, an authentication server for preventing an Adversary in the Middle (AiTM) attack on deployed Multi-Factor Authentication (MFA) system includes at least one memory, and a processing system that includes one or more processors coupled to the at least one memory. The processing system is configured to collect Internet Protocol (IP) addresses for electronic devices associated with a plurality of users and store the IP addresses in a database. The processing system is configured to receive a request for authentication for a user from a first electronic device and to acquire the IP addresses associated with first electronic device. The processing system is further configured to determine whether the IP address associated with the first electronic device matches an IP address associated with an electronic device associated with the user from the database, and to proceed with an authentication process for the user in response to a match between the IP address associated with the first electronic device and the IP address associated with the electronic device associated with the user from the database.

In one implementation, a method for preventing an Adversary in the Middle (AiTM) attack on deployed Multi-Factor Authentication (MFA) system includes collecting Internet Protocol (IP) addresses for electronic devices associated with a plurality of users and store the IP addresses in a database. The method includes receiving a request for authentication for a user from a first electronic device and determining whether a certificate is present in the request for authentication. The method includes proceeding with authentication for the user in response to a determination that the certificate is present in the request for authentication. In response to a determination that the certificate is not present in the request for authentication, the method includes acquiring the IP addresses associated with first electronic device and determining whether the IP address associated with the first electronic device matches an IP address associated with an electronic device associated with the user from the database. The request for authentication is rejected in response to a mismatch between the IP address associated with the first electronic device and the IP address associated with the electronic device associated with the user. The certificate is sent to the first electronic device in response to a match between the IP address associated with the first electronic device and the IP address associated with the electronic device associated with the user.

In one implementation, an authentication server for preventing an Adversary in the Middle (AiTM) attack on deployed Multi-Factor Authentication (MFA) system includes at least one memory, and a processing system that includes one or more processors coupled to the at least one memory. The processing system is configured to receive a request for authentication for a user from a first electronic device and determine whether a certificate is present in the request for authentication. The processing system proceeds with authentication for the user in response to a determination that the certificate is present in the request for authentication. In response to a determination that the certificate is not present in the request for authentication, the processing system acquires the IP addresses associated with first electronic device and determines whether the IP address associated with the first electronic device matches an IP address associated with an electronic device associated with the user from the database. The request for authentication is rejected in response to a mismatch between the IP address associated with the first electronic device and the IP address associated with the electronic device associated with the user. The certificate is sent to the first electronic device in response to a match between the IP address associated with the first electronic device and the IP address associated with the electronic device associated with the user.

In one implementation, a method for preventing an Adversary in the Middle (AiTM) attack on deployed Multi-Factor Authentication (MFA) system includes receiving a request for authentication for a user from a first electronic device and obtaining a video of the user via the first electronic device. The method includes determining whether an identity of the user is confirmed, by at least one of performing biometric matching of the video with biometric data for the user stored in a biometric database; and obtaining peer approval of the identity of the user based on a video review by one or more peers of the user within their organization. The request for authentication is rejected in response to a failure to confirm the identity of the user. The method further includes proceeding with authentication for the user in response to confirmation of the identity of the user.

In one implementation, an authentication server for preventing an Adversary in the Middle (AiTM) attack on deployed Multi-Factor Authentication (MFA) system includes at least one memory, and a processing system that includes one or more processors coupled to the at least one memory. The processing system is configured to receive a request for authentication for a user from a first electronic device and to obtain a video of the user via the first electronic device. The processing system determines whether an identity of the user is confirmed by being configured to perform biometric matching of the video with biometric data for the user stored in a biometric database, obtain peer approval of the identity of the user based on a video review by one or more peers of the user, or a combination thereof. The processing system rejects the request for authentication in response to a failure to confirm the identity of the user, and proceeds with authentication for the user in response to confirmation of the identity of the user.

### BRIEF DESCRIPTION OF DRAWINGS

FIG. 1 is a diagram illustrating an authentication system that may use MFA procedures.

FIG. 2 is a diagram illustrating an example of an Adversary in the Middle (AiTM) attack on an authentication system.

FIG. 3A illustrates an example process for using matching IP addresses to prevent an AiTM attack on an MFA system, in accordance with some implementations.

FIG. 3B illustrates an example process for matching IP addresses along with an additional security procedure to prevent an AiTM attack on an MFA system, in accordance with some implementations.

FIG. 4A illustrates an example process of using matching IP addresses along with certificates to prevent an AiTM attack on an MFA system, in accordance with some implementations.

FIG. 4B illustrates determining whether a valid certificate is present in the request for authentication.

FIG. 4C illustrates an example process for using matching IP addresses and certificates along with an additional security procedure to prevent an AiTM attack on an MFA system, in accordance with some implementations.

FIG. 5A illustrates an example process for using video verification to establish trust of an endpoint and prevent an AiTM attack on an MFA system, in accordance with some implementations.

FIG. 5B illustrates an example process of using video verification to establish trust of an endpoint along with certificates to prevent an AiTM attack on an MFA system, in accordance with some implementations.

FIG. 6 shows an example computer system that may operate as an authentication server and may be configured for verifying whether an initiating device is a trusted endpoint to counteract AiTM type attacks and to assist in certificate deployment and management.

FIGS. 7-9 are flow charts illustrating methods of preventing an AiTM attack on deployed MFA systems, in accordance with an implementation discussed herein.

### DETAILED DESCRIPTION

Multi-factor authentication (MFA) is an electronic authentication method used to authenticate a user, e.g., to provide the user with access to an account, website, application, etc., after the user successfully presents multiple pieces of evidence (or factors) of authenticity to an authentication system. For example, a user may be required to enter a password as one factor, and may be required to enter a code sent to the user's email or answer a security question as a second factor. The use of multiple forms of authentication provides an additional layer of security to protect digital assets and helps prevent unauthorized access to digital assets even if the user's password has been compromised. Organizations, such as businesses, may use multi-factor authentication to validate user identities and to provide quick and convenient access to authorized users.

While the use of MFA provides additional security to protect digital assets, there is a trade-off between security and convenience of the user. For example, one type of MFA system uses a third-party authenticator app that provides a randomly generated and frequently changing code that is entered by the user as a second factor. The requirement for the user to obtain the code from the third-party authenticator app is somewhat inconvenient for the user, but provides good security. A more convenient procedure for MFA is to push a notification for confirmation of an authentication attempt to a third-party authenticator app on a device associated with the user so that the user may simply click a button in response. For example, the user may initiate an authentication attempt by logging into an account via a browser on an initiating device, such as the user's computer, and the authentication system may push a notification for confirmation of authentication to a third-party authenticator app on a confirming device associated with the user, such as the user's mobile phone. The user may simply click an “accept” button presented on the confirming device as the second authentication factor in order to complete the login on the initiating device.

Pushing a notification for confirmation of authentication attempt to a confirming device associated with the user provides a convenient authentication experience for the user. However, attackers may compromise this MFA procedure through various types of attacks. In one type of attack on MFA systems, an attacker is between the user and the restricted computer system, which may be referred to as an Adversary-in-The-Middle (AiTM) MFA Attack. In an AiTM attack, the attacker circumvents MFA security by successfully impersonating each endpoint in the communication. For example, the attacker may trigger an authentication request from the attacker's unauthorized electronic device and deceive the actual user into confirming the authentication request with the authentication app on the user's electronic device.

One specific example of AiTM MFA attack is the Oktapus attack, in which communications such as text messages or calls, that mimic legitimate communications from an organization, are sent to users associated with the organization in a phishing campaign. The communications attempt to obtain the user's login details, e.g., user name and password for the user's account, for example, by convincing users to visit a link that redirects the user to a counterfeit login page controlled by the attackers. Once a user provides their login details, e.g., by attempting to login into the counterfeit login page, the attackers use the login details to login to the legitimate login page for the organization, which triggers an authentication request that is sent to the user. The user, incorrectly believing that they initiated the authentication request, will accept the authentication request, thereby giving the attackers access to the user's account.

One way to prevent AiTM MFA attacks is the use of a Transport Layer Security (TLS), in which one or both endpoints are authenticated using a mutually trusted certificate authority, e.g., an entity that stores, signs, and issues digital certificates. For example, by requiring the presence of a trusted certificate during authentication communications, attackers are unable to successfully bypass the MFA system. One problem with the use of certificates, however, is the issuance and updating of certificates to authorized users. For example, in a large organization, many user devices may be issued or replaced at the same time, making it logistically difficult to issue certificates to all of the devices. Similarly, certificates expire and require updating or users may switch, upgrade or add devices that require certificates. External third parties who have their own devices may require temporary access to the organization's network, and may be resistant to having the organization modify their devices. While the use of TLS certificates can make the system secure, the current process of manual issuance and management is complex and expensive. For these reasons, most organizations do not implement such a system for their authentication needs.

As discussed herein, an authentication system may prevent an AiTM attack on an MFA system in various ways without or in addition to the use of certificates or by simplifying the process for updating or issuing certificates. For example, an authentication system may collect and use Internet Protocol (IP) addresses for electronic devices associated with users during authentication. For example, in one implementation, the authentication may verify that an electronic device that sends a request for authentication, sometimes referred to herein as the initiating device, has the same IP address as a known IP address for an electronic device associated with an authorized user that will be used for confirming the request for authentication, sometimes referred to herein as the confirming device. If the IP addresses between the initiating device and confirming device match, it can be assumed that these endpoints are being used by the same user and may be trusted and the authentication system may proceed with the authentication request. An attacker's device that initiates an authentication request will very likely be on a network different from the user's confirming device.

In another implementation, the authentication system may use certificates to establish trust of the initiating device, and may issue or update certificates based on matching the IP addresses of the requesting and confirming devices. For example, in one implementation, if a valid certificate is not present in the request for authentication, the authentication system may verify that the initiating device has the same IP address as a known IP address for the confirming device associated with the user. Based on matching IP addresses between the initiating device and confirming device, the authentication system may proceed with issuing a valid certificate to the initiating device in order to proceed with the authentication request.

In another implementation, one or more endpoints may be verified using video of the user. For example, in response to an authentication request, the authentication system may capture video of the user from the initiating device and use the video to determine the requester's identity. The identity of the requester may be verified, e.g., using stored biometrics for the user that are compared to the video, using peer review of the video, or a combination thereof. If the requester's identity is confirmed as an authorized user, the requesting endpoint may be trusted and the authentication system may proceed with the authentication request.

It should be understood that examples of the authentication process or request for authentication is sometimes described herein as a user login for the sake of simplicity. The use of “authentication” herein, however, is not limited to only user login. Unless indicated otherwise, the term “authentication” should be broadly construed to include whenever a user's identity is to be confirmed, e.g., on a computer network, before the user can be granted access to certain physical or virtual resources, can take certain actions that require authorization, or can confirm an action taken.

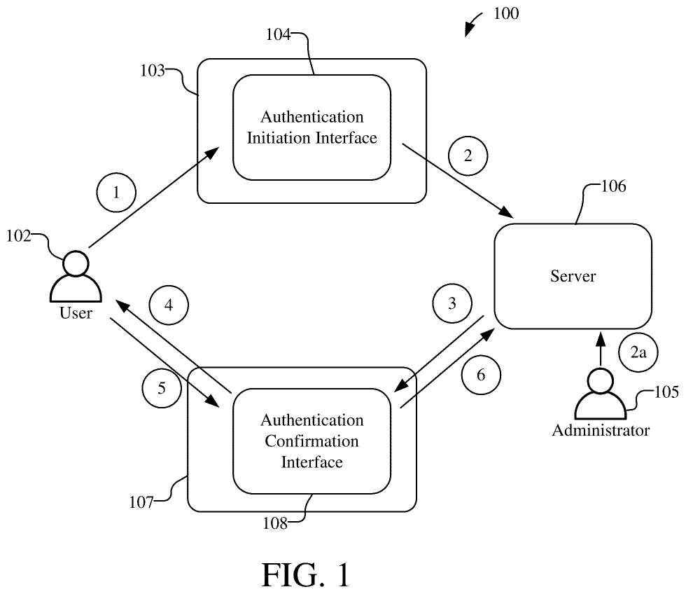

FIG. 1 is a diagram illustrating an authentication system 100 that may use MFA procedures. The authentication system 100 is illustrated performing a default MFA procedure in which, e.g., a notification for confirmation of authentication attempt is pushed to a confirming device 107 associated with a user 102 in response to a request for authentication received from an initiating device 103. The authentication system 100, or elements thereof, may be configured to perform any of the AiTM attack prevention procedures discussed herein.

As illustrated at step 1, a user 102 may initiate an authentication request using an initiating device 103, e.g., by attempting to login to an account, website, application, etc. The initiating device 103, for example, may be an electronic device, such as a computer, laptop, mobile phone, smart phone, tablet, or other electronic system. The authentication request may be initiated, for example, by the user 102 entering a user name, e.g., an email address, and password or other authenticating factor into the initiating device 103 to access the desired electronic asset, e.g., account, website, application, etc. Upon attempting to login or otherwise access the desired electronic asset, an Authentication Initiation Interface (AII) 104 in the initiating device 103, which may be a component of the login or access interface, or may be a separate component, initiates authentication request. In some implementations, the initiation of the authentication request may also or alternatively be an implicit initiation, such as when user 102 enters a physical area and the initiating device 103 associated with the user 102 is electronically detected as having entered the specific area.

At step 2, the initiating device 103, e.g., the AII 104, sends a request for authentication for the user to a computer system for authentication, e.g., server 106 that may sometimes be referred to as an authentication server, which is responsible for orchestrating various system components and data resources to authenticate a user's identity electronically, e.g., based on the user name, user's email address, mobile phone identifier, or other identifier, and password or other authenticating factor that the user entered into the initiating device 103. The server 106, for example, may check a database to determine whether the user 102 is part of a directory of an organization, whether the user 102 is currently deemed active, and whether the user 102 has the rights to complete the authentication. As discussed herein, the server 106 may perform a system-initiated endpoint verification to determine if the request for authentication for the user 102 is part of an AiTM attack, as discussed herein. Additionally, as illustrated by step 2a, an administrator 105 may contact the server 106, e.g., via computer interface (portal, web, mobile, etc.), and perform various administrative tasks, such as configuring lists including the user 102, or a group of users that include the user 102, including an entire organization, that may access the system.

At step 3, if the initiating device 103 is verified and there is no indication of an AiTM attack, e.g., determined using one or more processes discussed herein, the server 106 contacts a confirming device 107 associated with the user 102 to push a notification for confirmation of authentication attempt. The confirming device 107, for example, may be an electronic device, such as a computer, laptop, mobile phone, smart phone, tablet, or other electronic system that is registered with the server 106 as being associated with the user 102. The confirming device 107 is generally a different device than the initiating device 103. For example, the initiating device 103 may be a computer and the confirming device 107 may be a smart phone associated with the user 102. In some implementations, however, the initiating device 103 and the confirming device 107 may be the same device. The notification for confirmation of authentication attempt may be received by an Authentication Confirmation Interface (ACI) 108 in the confirming device 107. The ACI 108 may be, or may be part of, an authentication application or app on the confirming device 107 for example.

If there is an indication of an AiTM attack, the server 106 may place the authentication system in safe mode and may cancel any pending attempts at authentication (such as the attempt at authentication from steps 1 and 2). The server 106 may further prevent any subsequent attempts at authentication until the AiTM attack is resolved. In some implementations, the server 106 may modify the authentication procedure for subsequent attempts at authentication.

At step 4, if there is no indication of an AiTM attack, the confirming device 107, e.g., the ACI 108, may present a request for authentication confirmation to the user 102, e.g., via a display or other communication mechanism. The request for authentication confirmation presented to the user 102, for example, may include buttons (virtual buttons) that allow the user 102 to confirm that the user 102 initiated the attempt at authentication (accept), deny the user initiated the attempt at authentication (reject), and, in some implementations, indicate the user is unsure if the user initiated the attempt at authentication (unsure).

At step 5, the user 102 responds to the request for authentication confirmation from the confirming device 107, e.g., by selecting the appropriate button. In the present example, because the user 102 initiated the attempt at authentication at step 1, the user 102 should select the accept button confirming that the user initiated the attempt at authentication. If, however, the user 102 did not initiate the attempt at authentication (e.g., if an attacker initiated the attempt at authentication based on the user's compromised user name and password) or if the user 102 is not sure whether they initiated the attempt at authentication, the user 102 should select the reject button denying that they initiated the attempt at authentication or the unsure button indicating that they are unsure whether they initiated the attempt at authentication, thereby indicating that there is an AiTM attack.

At step 6, the confirming device 107, e.g., the ACI 108, provides the user response to the server 106, which can then either approve or deny the request for authentication received at step 2, accordingly.

While the initiating device 103 will typically include an identifier related to the user, such as the user's login information, in the request for authentication at step 2, this identification information may be compromised. For example, an attacker may trigger an authentication request from the attacker's machine using the user's login information, and the user may mistakenly confirm the authentication request. Accordingly, to prevent AiTM type attacks, the server 106 should verify that the initiating device 103 is a trusted endpoint prior to pushing the notification confirmation of the authentication attempt to the confirming device 107, as discussed herein.

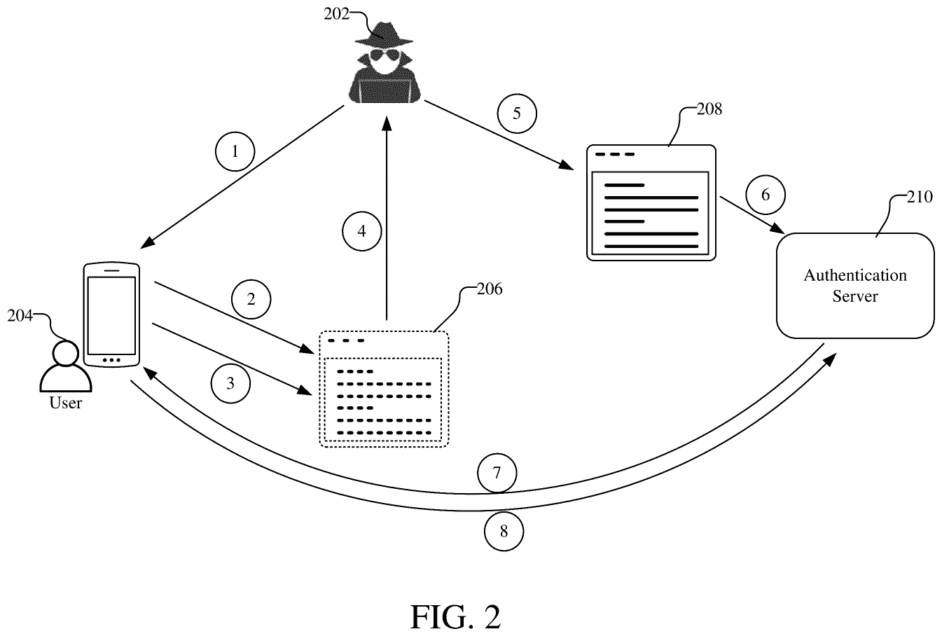

FIG. 2 is a diagram illustrating an example of an AiTM attack on an authentication system, illustrated by the authentication server 210. The AiTM attack illustrated in FIG. 2, for example, is similar to the Oktapus attack, but it should be understood that AiTM attacks may involve different approaches. While there are a variety of different AiTM type attacks on MFA systems, in general, they all include an attacker in the middle that mimics an endpoint of the MFA process.

As illustrated at step 1, the attacker 202 contacts the user 204 via the user's electronic device to obtain the user's login details, e.g., user name and password for the user's account. For example, the attacker 202 may send a text message to the user 204 that appears to originate from a legitimate source, asking the user to verify their authentication information. The attacker 202 may first contact the target via a phone call, pretending to be from the IT department checking on the user's authentication method, which is intended to reduce any potential suspicion the targeted user may have of an unexpected text message. The text message may include a link that directs the user to a counterfeit login page.

At step 2, the user 204 clicks the link within the text message and is directed to an attack website 206 that is controlled by the attacker 202. The attack website 206 mimics the login website that the user 204 would normally use for authentication.

At step 3, the attack website 206 requests the user's credentials, e.g., username and optionally password and, because the attack website 206 appears legitimate, the user 204 enters this information into the attack website 206.

At step 4, the attacker 202 acquires the user's credentials from the attack website 206. For example, the credentials may be acquired the moment they are entered by the user, e.g., by programmatic means.

At step 5, the attacker 202 enters the user's credentials into the legitimate login website 208, i.e., the AII on an initiating device controlled by the attacker 202. Entry of the user's credentials into the legitimate login website 208 may occur almost instantly after the user enters the credentials into the attack website 206, e.g., again by programmatic means. Entry of the user's credentials by the attacker 202 into the legitimate login website 208 initiates an authentication request pursuant to the MFA procedures.

At step 6, the login website 208, i.e., the AII on an initiating device controlled by the attacker 202, sends a request for authentication to the server 210, which like server 106 discussed in reference to FIG. 1, is responsible for orchestrating various system components and data resources to authenticate a user's identity electronically, e.g., based on the user name, user's email address, mobile phone identifier, or other identifier, and password or other authenticating factor received from the initiating device. The server 210, for example, may check a database based on the user's credentials provided by the attacker 202 to determine whether the user 204 is included in a directory of an organization, whether the user 204 is currently deemed active, and whether the user 204 has the rights to complete the authentication.

At step 7, in response to because receiving the correct credentials for the user 204 from the initiating device controlled by the attacker 202, the server 210 proceeds with the authentication procedure and contacts a confirming device associated with the user 204 to push a notification for confirmation of authentication attempt.

At step 8, the user 204, who is expecting a request for the confirmation of the authentication attempt due to the user's entry of the credentials into the attack website 206, confirms the request for authentication from the user's confirming device, and the confirming device provides the user response to the server 210, which provides the attacker 202 with access to the user's account at the login website 208.

The attacker 202 now has access to the account of the target user 204 can proceed to take control of the account and progress further steps in the account compromise.

As noted, AiTM type attacks on MFA systems may vary from the example illustrated in FIG. 2. For example, the user 204 may be deceived in various ways and various types of communications may be used. The attacker 202, for example, may call the user 204 and pretend to be from the IT department “checking” the user's login credentials and directing the user 204 to the attack website 206, and thus, no text message is necessary. Alternatively, the user 204 may be directed to the attack website 206 via electronic mail (email). Regardless of the exact mechanism of the AiTM attack, upon confirmation of the request for authentication by the user 204, the attacker's authentication attempt is authorized, and the attacker 202 then gains access to restricted computer resources.

Accordingly, to counteract AiTM type attacks, a trusted endpoint approach may be used. Endpoints are computer systems, such as laptops, tablets, smart phones, etc., that operate as the initiating device, e.g., devices that contain the AII that initiates the request for authentication. Computer systems that operate as the confirming device, e.g., devices that contain the ACI, may also be considered an endpoint. In some implementations, the initiating device and the confirming device may be the same device, i.e., the AII and ACI may be on the same computer system. The confirming device, however, is presumed to be secure, e.g., in the legitimate user's possession. Additionally, the confirming device primarily interacts with the authentication server and does not need to interact with the restricted computer resources, e.g., the network that the user (or attacker) is attempting to access. In the trusted endpoint approach, the authentication system is gating access to the restricted computer sources to the initiating device, and, accordingly, the endpoint that requires securing is the initiating device, i.e., computer system that contains the AII. The AII in the initiating device initiates the authentication request, for example, when the user enters their credentials. By adding an element of trust to this endpoint, in that only trusted endpoints may initiate authentication requests, the AiTM attacks, such as illustrated in FIG. 2, may be greatly mitigated. The trusted endpoint approach requires that only the user's devices are trusted endpoints, not the attacker's devices.

In one approach, trust may be established for an endpoint using a unique hardware key containing a public-key certificate such as embedded within an U2F (Universal 2^{nd} Factor) key that is linked to the endpoint. The security claim here is that only the legitimate user can possess the certificate. Thus, if a request for authentication includes a certificate, it may be presumed that only the user could have initiated the authentication attempt.

In another approach, trust may be established for an endpoint using a unique software certificate that is pushed to the endpoint before first use for authentication. When initiating an authentication attempt, the endpoint sends the certificate to the server, which validates the certificate and then verifies whether the endpoint is allowed to initiate an authentication attempt before proceeding with the authentication procedure.

In another approach, trust may be established for an endpoint using a hardware identifier that is tied to the endpoint, provided usually by the operating system on the endpoint, that is then used to identify the endpoint to the authentication server. The authentication server uses this identifier to verify that the authentication attempt is coming from the correct user before proceeding with the authentication procedure.

While such approaches should prevent the above attacks, in practice, they have not gained widespread adoption. Reluctance to adopt these approaches is at least partly due to the significant costs incurred by an organization's IT department to implement trusted endpoints. There are multiple considerations apply to rolling out and maintaining a trusted endpoint system with current technology. For example, to establish trust for an endpoint, significant IT work within an organization is needed. Individuals within the IT department must generate the necessary certificate or activate the required U2F key or procure the hardware identifier for the endpoint, and this data must then be entered into a centralized database. The trusted endpoints and the U2F key if applicable, must then be distributed across the organization in a secure manner. The database then must be maintained and kept current. For example, devices may be upgraded, devices may be deactivated, and new devices may be activated. Further, users may lose devices, and certificates may expire over time and require re-authorization. In such cases, additional work is required to generate the necessary certificates, activate the required U2F key, or procure the hardware identifier and update the database. Additionally, U2F keys are generally small in form factor and are easily lost or misplaced, which leads to higher overhead in the IT department for this approach. Moreover, organizations sometimes need to allow access to their networks to external organizations, such as vendors, and consequently, it may be necessary to issue endpoints for these external organizations. The issuance and management of trusted endpoints for external organizations creates additional work and complications. Additionally, external organizations may already have their endpoints within their own organization and therefore may not wish to take on another set of endpoints for their usage.

Many organizations have limited IT budgets, and the above considerations render current trusted endpoints impractical for most organizations, leading to lack of adoption.

Accordingly, the need exists for an MFA system where endpoints can be trusted while needing minimal management overhead for deployment or maintenance. An authentication system, as described herein, may use IP addresses or video of the user to separate legitimate requests from those that originate from attackers or to assist in certificate deployment and management. It should be understood that while these methods may be presented herein separately, optionally they may be combined to provide even greater security.

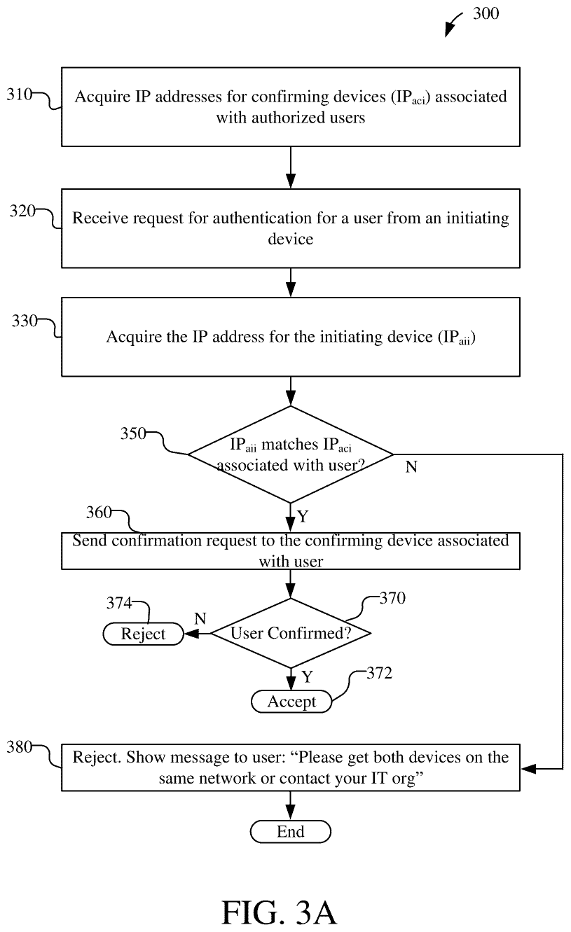

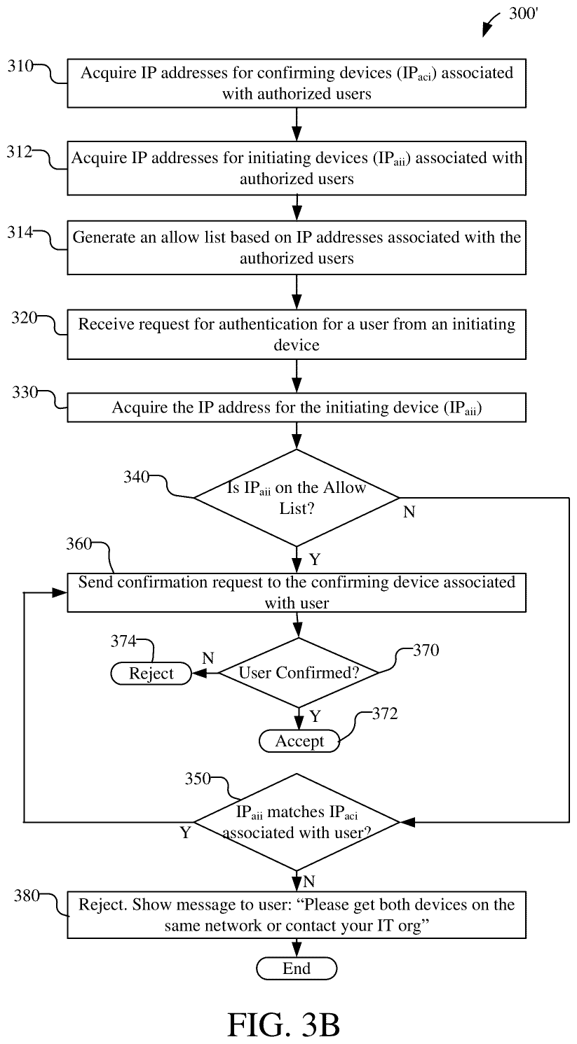

FIG. 3A illustrates an example process 300 for using IP addresses to prevent an AiTM attack on an MFA system, in accordance with some implementations. The example illustrated in FIG. 3A uses matching IP addresses for the initiating device and the confirming device to verify that the initiating device is a trusted endpoint and is sometimes referred to herein as an IP Address Concordance Algorithm (IPACA). The process of verifying the initiating device as a trusted endpoint may be implemented on the authentication server, such as server 106 shown in FIG. 1, or another computer systems acting on behalf of the authentication server. The use of IP addresses advantageously separates high-risk authentication attempts from low-risk authentication attempts. For example, a conventional authentication procedure, such as illustrated in FIG. 1, may be used if the authentication attempt is low risk, while a high-risk authentication procedure may be rejected or referred to an administrator for assistance.

As illustrated, at 310, the authentication server acquires IP addresses associated with electronic devices associated with authorized users. The electronic devices may be used as confirming devices, e.g., including an ACIs, for the authorized users and accordingly, the IP addresses for the electronic devices may sometimes be referred to as IP_{aci}. The confirming device for users may be contacted by the authentication server to confirm activities, usually via an intermediary system such as Apple Push Notification Services. The IP address IP_{aci} of the confirming devices may not usually be available via these intermediary services. However, the authentication server needs the IP_{aci} to execute the IPACA. The IP_{aci} may be acquired passively, before the authentication server needs to contact the confirming device to confirm any activities or requests. In one implementation, for example, the confirming devices of users may periodically contact the authentication server. In these contact messages, usually termed ping messages, the confirming devices may transfer any other data that the authentication server requires. In another example implementation, the confirming devices of the users may update the authentication server of its IP address at startup and anytime when it changes. The confirming devices may acquire the IP addresses using a variety of means. For example, the operating system on which the ACI executes can provide the current IP address for the ACI or the device on which it is executing. In another example, the ACI may contact external servers that detect and provide the IP address of the ACI back to it. The ACI may also receive notifications from the operating system when its IP address changes. Thus, at startup and whenever the IP address changes, the confirming device may send, e.g., via the ACI, a message, termed an update message, to the authentication server. These ping or update messages may include one or more of: an identifier issued by the authentication server, the user information associated with the confirming device or ACI, a or certificate issued by the authentication server or an external third party trusted by the authentication server, or the IP address as seen by the ACI. The authentication server thus acquires the IP address IP_{aci} from which these messages originate, and the associated data transferred, and stores these in an internal database.

At 320, the authentication server receives a request for authentication for a user from an initiating device. For example, the receipt of a request for authentication for a user is illustrated at step 2 in FIG. 1 in which an authorized user has initiated the request and is illustrated in step 6 of FIG. 2 in which an attacker has initiated the request. When an initiating device sends the request for authentication, it will typically include an identifier for the user who is seeking authentication services, e.g., such as the user's email address, which may be used by the authentication server to look up the user within an internal database.

At 330, the authentication server acquires the IP address for the initiating device that sent the request for authentication received at 320. The initiating device may include an AII and, accordingly, the IP address for the initiating device may sometimes be referred to as IPₐᵢᵢ.

At 350, the authentication server determines whether the IP address IPₐᵢᵢ of the initiating device matches the IP address of the confirming device IP_{aci} that is associated with the user. For example, when a request for authentication is received from the initiating device at 320, it contains information about the user for which authentication is requested. The authentication server then looks up the user in a database based on this information and retrieves the last-reported IP address of the confirming device IP_{aci} associated with the user. This could either be the IP address that the ACI reported or the IP address acquired by the authentication server that was associated with the origin of the ping messages. In a regular authentication scenario, such as when the user is attempting to connect from home, it is reasonable to expect that the user has both the initiating device and the confirming device on the same network, and thus will have the same IP address. For example, in one typical scenario, the initiating device may be a laptop computer that is connected via WiFi to an internal wireless router. The confirming device may be a mobile phone that may also be connected to the same WiFi network for internet access. The wireless router acquires an IP address from the internet service provider (e.g. AT&T or Comcast), and through the regular Network Address Translation (NAT) process, all devices connected to the router are given this IP address for any external traffic. At the Authentication Server, because of NAT, the IP address for the initiating device IPₐᵢᵢ will match the IP address of the confirming device IP_{aci}. Since both these devices are connected to the same WiFi router, and the signals from a WiFi router are confined to a small area, it is reasonable to conclude that both these devices are proximate to each other. In another scenario, the initiating device and the confirming device may be the same mobile phone, in which case the IP addresses of the initiating device and the confirming device will match.

At 360, in response to a match between the IP address IPₐᵢᵢ of the initiating device and the IP address of the confirming device IP_{aci} that is associated with the user at step 350, the authentication attempt may be deemed low-risk, and the authentication server may proceed with the normal authentication procedure, e.g., by sending a confirmation request to the confirming device associated with the user, e.g., similar to step 3 shown in FIG. 1. The authentication attempt may be deemed low risk because if the initiating device is using the same IP address as the confirming device associated with the user, as explained above, the initiating device is highly likely to be in the same location as the confirming device and presumably in the possession of the user. Accordingly, the initiating device may be presumed to be a trusted endpoint.

At 370, if the user confirms the authentication request on the confirming device, then the request for authentication is accepted at 372. Confirmation can be effectuated by one or more of the following: a user pressing a button on the ACI, a user entering a code or password into the ACI, a user confirming via biometrics. On the other hand, if the user rejects the authentication request on the confirming device, then the request for authentication is rejected at 374.

At 380, in response to a mismatch between the IP address IPₐᵢᵢ of the initiating device and the IP address of the confirming device IP_{aci} that is associated with the user at step 340, the authentication attempt may be deemed high-risk and the authentication attempt may be rejected. In some implementations, the authentication server may send a message to the initiating device instructing the user to make sure that the initiating device and the confirming device are connected to the same network, e.g., so that they will have the same IP address, or to contact an administrator to assist with authentication. A legitimate user may easily ensure that the initiating device and confirming device are on the same network, but if not, the user may contact an administrator for assistance. For an attack, such as illustrated in FIG. 2, the attacker is likely to be geographically very far from the user and the confirming device. Thus, the IP address IPₐᵢᵢ of the initiating device in the attacker's possession will not match the IP address of the confirming device IP_{aci} that is with the user, and therefore the attack is neutralized.

In some implementations, the procedure illustrated in FIG. 3A may be combined with additional security procedures to further increase security of the MFA system.

FIG. 3B, by way of example, illustrates an example process 300′ for using IP addresses along with an additional security procedure of an allow list to prevent an AiTM attack on an MFA system, in accordance with some implementations. The example illustrated in FIG. 3B is similar to the procedure illustrated in FIG. 3A, like designated elements being the same. The additional security procedure, however, further strengthens security and may increase convenience to users.

As illustrated in FIG. 3B, in addition to acquiring the IP addresses IP_{aci} for confirming devices associated with authorized users at step 310, at 312, the IP addresses for initiating devices IPₐᵢᵢ associated with authorized users is collected. The IP addresses IPₐᵢᵢ may be collected in a similar manner as the IP addresses IP_{aci} for confirming devices. Additionally, or alternatively, the authentication server may acquire the IP addresses IPₐᵢᵢ used by the endpoints of an organization that is using the authentication services of the authentication server. For example, the organization may provide a database of allowed IP addresses. The allowed IP addresses may be sets of ranges of IP addresses that are considered to belong to the organization, or to one or more of its groups, or to one or more of its users.

At 314, an allow list is generated based on the IP addresses associated with the authorized users and their endpoints belonging to that organization. The assumption for the allow list is that if the initiating device is on a known network, i.e., with an IP address that is on the allow list, then the initiating device may be presumed to be safe, because the organization will take stringent precautions to keep out unauthorized endpoints from their internal networks. Thus, an attacker's authentication requests will originate from an outside network. The allow list may be configurable by system administration. For example, the system administrator may configure the allow list by entering the allowed IP addresses in the administrative portal. In another example, the authentication server may periodically poll a server that the organization controls, which lists the current IP addresses in use by the organization.

At 340, after receiving a request for authentication and acquiring the IP address for the initiating device IPₐᵢᵢ at steps 320 and 330, as discussed in FIG. 3A, the authentication server may determine if the IP address for the initiating device IPₐᵢᵢ is on the allow list. If the IP address for the initiating device IPₐᵢᵢ is not on the allow list, the process may flow to step 350, which is discussed in FIG. 3A. If, however, IP address for the initiating device IPₐᵢᵢ is on the allow list, then the authentication server may deem the request for authentication to be a low-risk, and may proceed with the authentication procedure illustrated by steps 360, 370, 372, and 374.

If both the allow list test at step 350 and the matching IP address test at step 350 fail, the attempt is considered high-risk. In this eventuality, the authentication attempt is blocked at step 380. In some implementations, the authentication server may send a message to the initiating device instructing the user to make sure that the initiating device and the confirming device are connected to the same network, e.g., so that they will have the same IP address, or to contact an administrator to assist with authentication.

In another implementation, the use of matching IP addresses for the initiating device and the confirming device to verify that the initiating device is a trusted endpoint, such as illustrated in FIG. 3A may be combined with additional security procedures, such as the use of certificates, to further increase security of the MFA system.

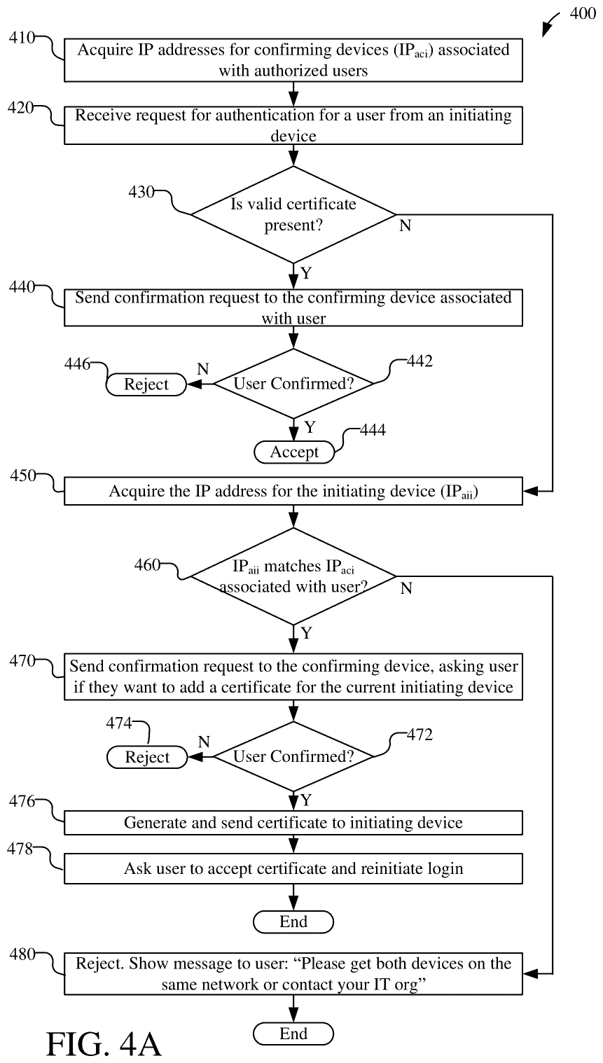

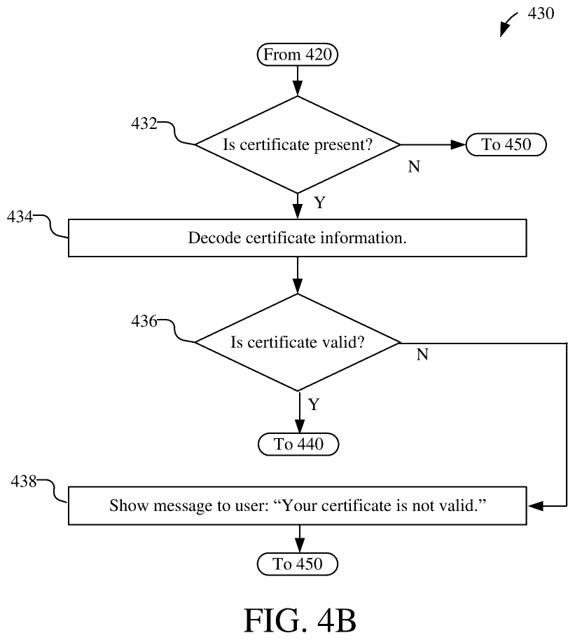

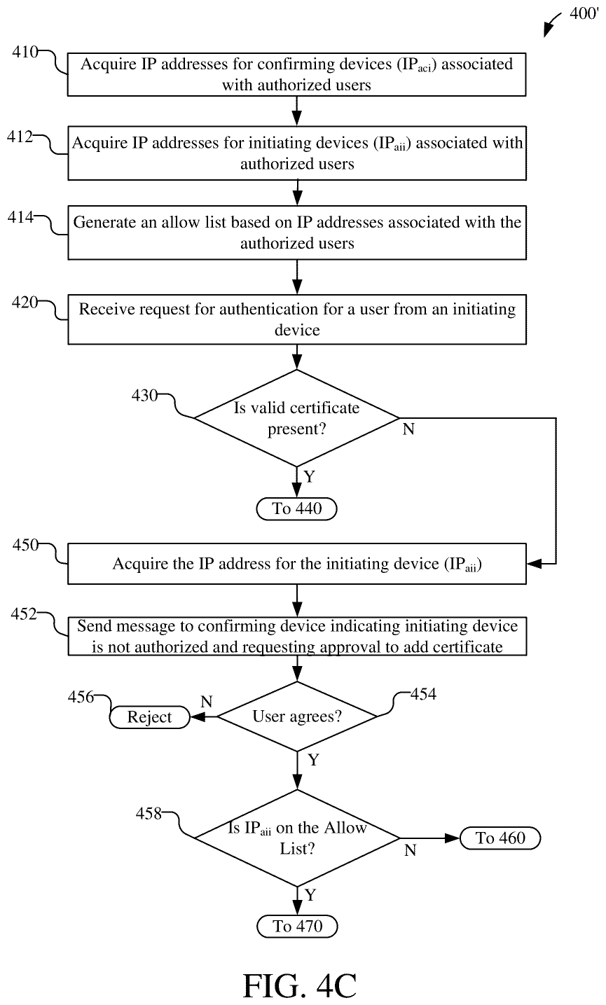

FIG. 4A illustrates an example process 400 of using IP addresses along with an additional security procedure of the use of certificates to prevent an AiTM attack on an MFA system, in accordance with some implementations. The example illustrated in FIG. 4A uses matching IP addresses for the initiating device and the confirming device to verify that the initiating device is a trusted endpoint, which may be used to issue or update certificates, and is sometimes referred to herein as an IP Address Concordance With Certificates Algorithm (IPACWCA). In this method, the initiating device must present a valid certificate to be able to authorize the initiation of the authentication procedure. Only if a certificate is present will the authentication server send a request for confirmation to a confirming device. If a certificate is not present, then the authentication server may use the IP addresses to determine if the initiating device is a trusted endpoint in a process of creating and sending a certificate to the initiating device. The process of detecting and verifying the certificate and verifying the initiating device as a trusted endpoint may be implemented on the authentication server, such as server 106 shown in FIG. 1, or another computer systems acting on behalf of the authentication server. As discussed in FIGS. 3A and 3B, the use of IP addresses advantageously separates high-risk authentication attempts from low-risk authentication attempts. For example, if the authentication attempt is deemed to be low risk, but a valid certificate is missing, the certificate may be issued to the initiating device, while a high-risk authentication attempt may be rejected or referred to an administrator for assistance.

As illustrated, at 410, the authentication server acquires IP addresses associated with electronic devices associated with authorized users, similar to step 310 discussed in FIG. 3A. The electronic devices may be used as confirming devices, e.g., including an ACIs, for the authorized users and accordingly, the IP addresses for the electronic devices may sometimes be referred to as IP_{aci}. The confirming device for users may be contacted by the authentication server to confirm activities, usually via an intermediary system such as Apple Push Notification Services. The IP address IP_{aci} of the confirming devices may not usually be available via these intermediary services. However, the authentication server needs the IP_{aci} to execute the IPACA. The IP_{aci} may be acquired passively, before the authentication server needs to contact the confirming device to confirm any activities or requests. In one implementation, for example, the confirming devices of users may periodically contact the authentication server. In these contact messages, usually termed ping messages, the confirming devices may transfer any other data that the authentication server requires. In another example implementation, the confirming devices of the users may update the authentication server of its IP address at startup and anytime when it changes. The confirming devices may acquire the IP addresses using a variety of means. For example, the operating system on which the ACI executes can provide the current IP address for the ACI or the device on which it is executing. In another example, the ACI may contact external servers that detect and provide the IP address of the ACI back to it. The ACI may also receive notifications from the operating system when its IP address changes. Thus, at startup and whenever the IP address changes, the confirming device may send, e.g., via the ACI, a message, termed an update message, to the authentication server. These ping or update messages may include one or more of: an identifier issued by the authentication server, the user information associated with the confirming device or ACI, a or certificate issued by the authentication server or an external third party trusted by the authentication server, or the IP address as seen by the ACI. The authentication server thus acquires the IP address IP_{aci} from which these messages originate, and the associated data transferred, and stores these in an internal database.

At 420, the authentication server receives a request for authentication for a user from an initiating device. For example, the receipt of a request for authentication for a user is illustrated at step 2 in FIG. 1 in which an authorized user has initiated the request and is illustrated in step 6 of FIG. 2 in which an attacker has initiated the request. When an initiating device sends the request for authentication, it will typically include an identifier for the user who is seeking authentication services, e.g., such as the user's email address, which may be used by the authentication server to look up the user within an internal database. Additionally, the request for authentication from an initiating device is expected to include a certificate in order to proceed with the authentication procedure. The certificate, for example, may be any type of a public key certificate, also known as a digital certificate or identity certificate, generated and issued by a trusted source, such as the authentication server itself or a third party that is trusted by the authentication server. A set of certificate issuers trusted by the authentication server may be configurable, e.g., according to industry standards. In some implementations, the set of certificate issuers trusted by the authentication server may be specified to the authentication server when it starts up and/or may be updated occasionally automatically by the authentication server or via administrative control.

At 430, the authentication server determines if a valid certificate is present in the request for authentication. For example, the authentication server may determine if the initiating device presents a certificate, and if so, the authentication server decodes the information contained in the certificate. The authentication server may then determine if the certificate presented is valid. A certificate may be determined to be valid if the issuer is trusted and the certificate has not expired. In addition, the authentication server may determine if the certificate presented corresponds with one previously issued to the user who is attempting authentication. The authentication server, for example, may look up the user in an internal database and retrieve any associated certificate information which is compared to the information from the received certificate in making this determination.

At 440, in response to a valid certificate being presented, the authentication request may be deemed to be a low-risk authentication attempt and the authentication server may proceed with the normal authentication procedure, e.g., by sending a confirmation request to the confirming device associated with the user, e.g., similar to step 3 shown in FIG. 1.

At 442, if the user confirms the authentication request on the confirming device, then the request for authentication is accepted at 444. Confirmation can be effectuated by one or more of the following: a user pressing a button on the ACI, a user entering a code or password into the ACI, a user confirming via biometrics. On the other hand, if the user rejects the authentication request on the confirming device, then the request for authentication is rejected at 446.

At 450, the authentication server may acquire the IP address for the initiating device IPₐᵢᵢ that sent the request for authentication received at 420 so that the process may proceed to determine if the initiating device is a trusted endpoint using IP addresses, similar to the process discussed in FIG. 3A. The acquiring of the IP address for the initiating device IPₐᵢᵢ may be in response to a valid certificate not being present at step 430 or may be performed earlier, e.g., at the time of receiving the request for authentication at step 420.

At 460, the authentication server determines whether the IP address IPₐᵢᵢ of the initiating device matches the IP address of the confirming device IP_{aci} that is associated with the user. For example, the request for authentication received from the initiating device at 420, may contain information about the user for which authentication is requested. The authentication server may look up the user in a database based on this information and retrieve the last-reported IP address of the confirming device IP_{aci} associated with the user. In some implementations, prior to proceeding with the procedure to determine if the initiating device is a trusted endpoint using IP addresses, e.g., prior to step 460 or prior to step 450, the authentication server may send message to the confirming device associated with the user to inform the user that the initiating device is not authorized and ask if the user would like to authorize the initiating device. If the user responds to the message indicating that they do not want to authorize the initiating device, the certificate-addition attempt is aborted and the request for authorization is rejected. If the user responds to the message indicating that they do want to authorize the initiating device, then the authentication server may proceed with the process. In some implementations, the IP address of the confirming device IP_{aci} associated with the user may be acquired from the response message, thereby obviating step 410, discussed above, as well as the need to maintain a database of IP addresses of the confirming device IP_{aci} associated with authorized users.

At 470, in response to a match between the IP address IPₐᵢᵢ of the initiating device and the IP address of the confirming device IP_{aci} that is associated with the user at step 460, the authentication attempt may be deemed low-risk, and the authentication server may proceed with the certificate-addition attempt, e.g., by sending a confirmation request to the confirming device associated with the user, asking the user if they wish to add a certificate for the initiating device. The authentication attempt may be deemed low risk because if the initiating device is using the same IP address as the confirming device associated with the user, the initiating device is in the same location as the confirmation device and highly likely in the possession of the user. Accordingly, the initiating device may be presumed to be a trusted endpoint.

At 472, if the user rejects the confirmation request, then the certificate-addition attempt is rejected at 474. If instead the user accepts the confirmation request, the certificate may be generated by the authentication server, or acquired from a trusted third party, and sent to the initiating device at 476. The authentication server may map the user to the certificate and store that mapping in an internal database for future use. At 478, a message may be sent to the user, e.g., at the confirming device or the initiating device, instructing the user to accept the certificate and then to re-initiate an authentication attempt from the initiating device. If the user accepts the certificate, that certificate is now valid, and the next authentication attempt may be re-initiated and the authentication process proceeds accordingly, e.g., the authentication server will receive the request for authentication for the user from the initiating device, which now includes a valid certificate, as described in steps 420 and 430. In some implementations, the AII may accept the certificate automatically on behalf of the user. In some implementations, the AII may retry the authentication request automatically as well.

At 480, in response to a mismatch between the IP address IPₐᵢᵢ of the initiating device and the IP address of the confirming device IP_{aci} that is associated with the user at step 460, the authentication attempt may be deemed high-risk and the authentication attempt and the request for authentication may be rejected. In some implementations, the authentication server may send a message to the initiating device instructing the user to make sure that the initiating device and the confirming device are connected to the same network, e.g., so that they will have the same IP address, or to contact an administrator to assist with authentication. A legitimate user may easily ensure that the initiating device and confirming device are on the same network, but if not, the user may contact an administrator for assistance. For an attack, such as illustrated in FIG. 2, however, the IP address IPₐᵢᵢ of the initiating device will not match the IP address of the confirming device IP_{aci} and therefore the attack is neutralized.

FIG. 4B, by way of example, illustrates additional details of step 430 from FIG. 4A for determining whether a valid certificate is present in the request for authentication.

As illustrated, at 432, the authentication server may determine if the initiating device presents a certificate in the request from authentication received at step 420. If no certificate is present, the process may proceed to step 450 in FIG. 4A.

At 434, in response to the presence of a certificate, the authentication server decodes the information contained in the certificate.

At 436, the authentication server may determine whether the certificate presented is valid. For example, a certificate may be determined to be valid if the issuer is trusted and the certificate has not expired. In addition, the authentication server may determine if the certificate presented corresponds with one previously issued to the user who is attempting authentication. The authentication server, for example, may look up the user in an internal database and retrieve any associated certificate information which is compared to the information from the received certificate in making this determination. If the certificate is determined to be valid, the process may proceed to step 440 in FIG. 4A.

At 438, in response to a determination that the certificate is not valid, the authentication server may send a message to the user, e.g., at the initiating device, the confirming device, or both, indicating that the certificate is not valid. The process may proceed to step 450 in FIG. 4A.

In some implementations, the procedures illustrated in FIGS. 4A and 4B may be combined with additional security procedures to further increase security of the MFA system.

FIG. 4C, by way of example, illustrates an example process 400′ for using IP addresses and certificates, along with an additional security procedure of an allow list to prevent an AiTM attack on an MFA system, in accordance with some implementations. The example illustrated in FIG. 4C is similar to the procedure illustrated in FIG. 4A, like designated elements being the same. The additional security procedure, however, further strengthens security and may increase convenience to users.

As illustrated in FIG. 4C, in addition to acquiring the IP addresses IP_{aci} for confirming devices associated with authorized users at step 410, at 412, the IP addresses for initiating devices IPₐᵢᵢ associated with authorized users is collected. The IP addresses IPₐᵢᵢ may be collected in a similar manner as the IP addresses IP_{aci} for confirming devices. Additionally, or alternatively, the authentication server may acquire the IP addresses IPₐᵢᵢ used by the endpoints of an organization that is using the authentication services of the authentication server. For example, the organization may provide a database of allowed IP addresses. The allowed IP addresses may be sets of ranges of IP addresses that are considered to belong to the organization, or to one or more of its groups, or to one or more of its users.

At 414, an allow list is generated based on the IP addresses associated with the authorized users and their endpoints belonging to that organization. The assumption for the allow list is that if the initiating device is on a known network, i.e., with an IP address that is on the allow list, then the initiating device may be presumed to be safe, because the organization will take stringent precautions to keep out unauthorized endpoints from their internal networks. Thus, an attacker's authentication requests will originate from an outside network. The allow list may be configurable by system administration. For example, the system administrator may configure the allow list by entering the allowed IP addresses in the administrative portal. In another example, the authentication server may periodically poll a server that the organization controls, which lists the current IP addresses in use by the organization.

As illustrated, after determining that a valid certificate is not present in step 430 and acquiring the IP address for the initiating device IPₐᵢᵢ at step 450, at 452 the authentication server may send a message to the confirming device associated with the user to inform the user that the initiating device is not authorized and requesting approval to add a certificate to the initiating device in order to authorize the initiating device.

At 454, the authentication server determines if the user agrees to authorize the initiating device, and if not, the request for authorization is rejected at 456. In some implementations, the IP address of the confirming device IP_{aci} associated with the user response may be acquired from the response message, thereby obviating step 410, discussed above, as well as the need to maintain a database of IP addresses of the confirming device IP_{aci} associated with authorized users.

At 458, in response to receiving agreement from the user to authorize the initiating device at step 454, the authentication server may determine if the IP address for the initiating device IPₐᵢᵢ is on the allow list. If the IP address for the initiating device IPₐᵢᵢ is not on the allow list, the process may flow to step 460, which is discussed in FIG. 4A. If, however, the IP address for the initiating device IPₐᵢᵢ is on the allow list, then the authentication server may deem the request for authentication to be a low-risk, and may proceed to step 470.

A benefit of the use of matching IP addresses is that it ensures the initiating device is proximate to the confirming device. The presumption is that an attacker will be in a different location than the legitimate user, and accordingly, the initiating device used by the attacker will have a different IP address than the confirming device in possession of the legitimate user. While the use of matching IP addresses is used to infer proximity of the initiating and confirming device, other technological approaches are possible.

For example, one or both of the initiating device and the confirming device may have location services, and the AII and ACI may contact the underlying operating systems for geolocation information. The acquired location information may be transferred to the authentication server. The locational information can then be used to ensure proximity of the initiating device and the confirming device instead of or in addition to the use of IP addresses in the above methods.

In another example, the initiating device and the confirming device may have access to short-range wireless technology, such as Bluetooth or Near Field Communication technology. The AII and ACI on the initiating device and the confirming device, respectively, may access this communication channel and exchange identifying information and then this information may be sent to the authentication server for comparison to confirm proximity before the completion of authentication or the addition of certificates. The authentication server may delegate this comparison step to another computer system acting on the server's behalf.

In another example, the AII or the ACI on the initiating device or the confirming device, respectively, may generate a visual code such as a QR code or a dynamic visual code. The code may be displayed by either the AII or the ACI, while the other acquires the code via a camera. The code may then be sent to the authentication server for comparison to confirm proximity before the completion of authentication or the addition of certificates. The authentication server may delegate this comparison step to another computer system acting on the server's behalf.

In one implementation, video of the user may be used for verification of an endpoint. For example, many computer devices that may be used as endpoints, such as laptops, smartphones, and tablets, have cameras that can record a video of the user. A video of the user may be captured from the endpoint serving as the initiating device, and the video may be used to verify the requester's identity, which may be used to establish trust of this endpoint.

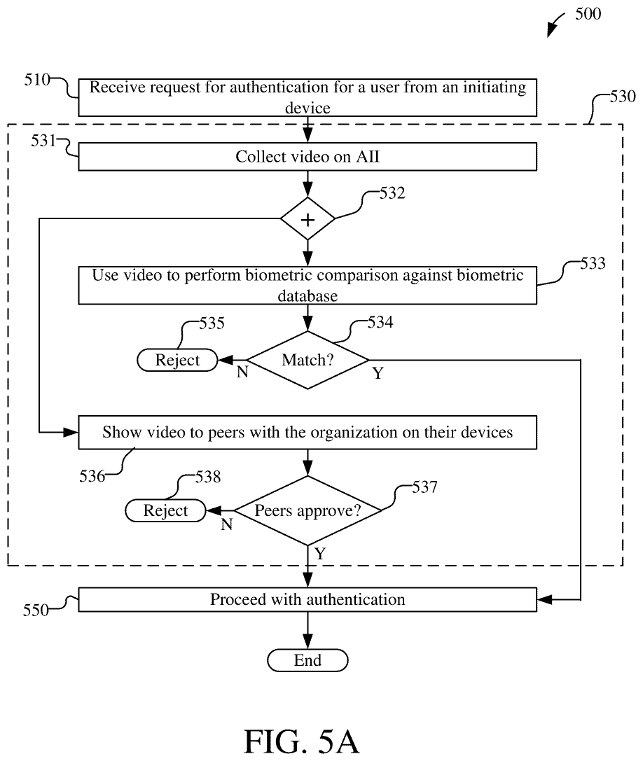

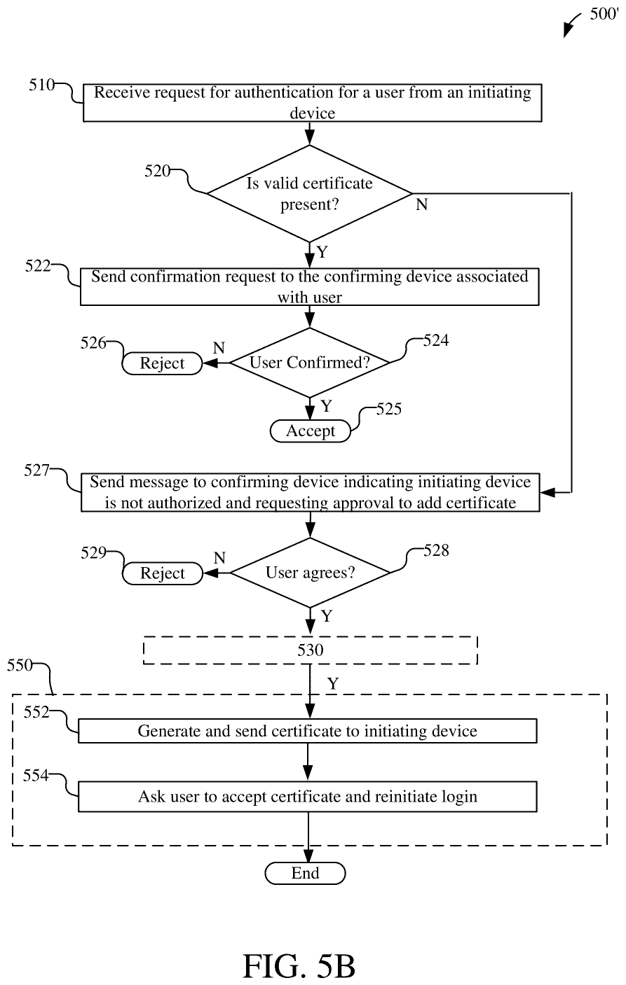

FIG. 5A illustrates an example process 500 for using video to establish trust of an endpoint and prevent an AiTM attack on an MFA system, in accordance with some implementations. The example illustrated in FIG. 5A uses video of the requester captured from the initiating device, which may be verified based on biometrics, peer review, or both, to verify that the initiating device is a trusted endpoint, and is sometimes referred to herein as Video Verified Endpoint Trust Algorithm (VVETA). The process of verifying the initiating device as a trusted endpoint may be implemented on the authentication server, such as server 106 shown in FIG. 1, or another computer systems acting on behalf of the authentication server. The use of video addresses advantageously separates high-risk authentication attempts from low-risk authentication attempts. For example, a conventional authentication procedure, such as illustrated in FIG. 1, may be used if the authentication attempt is low risk, while a high-risk authentication procedure may be rejected or referred to an administrator for assistance.

As illustrated, at 510, the authentication server receives a request for authentication for a user from an initiating device. For example, the receipt of a request for authentication for a user is illustrated at step 2 in FIG. 1 in which an authorized user has initiated the request and is illustrated in step 6 of FIG. 2 in which an attacker has initiated the request. When an initiating device sends the request for authentication, it will typically include an identifier for the user who is seeking authentication services, e.g., such as the user's email address, which may be used by the authentication server to look up the user within an internal database.

At 530, as illustrated video, (which may optionally include audio) of the user collected at the initiating device is used to verify the initiating device as a trusted endpoint and the authentication attempt is low-risk, or to establish that the authentication attempt is high-risk and should be rejected or referred to an administrator for assistance.

For example, at 531, video of the user is collected by the initiating device, e.g., by the AII in the initiating device. In some implementations, the authentication server may cause the video of the user to be collected by the initiating device after seeking appropriate permission, or the video may be automatically collected by the initiating device before sending the request for authentication to the authentication server.

As illustrated at 532, the authentication server may confirm the user identity in one or multiple ways, by proceeding either to 533 or to 536.

At 533, the authentication server performs a biometric comparison of the video of the user against a biometric data for the user acquired from a biometric database. The biometric database, for example, may be established with an enrollment of the user. This database may reside on the authentication server, the confirming device, or the initiating device. The authentication server uses the user's identifier provided by the initiating device in the request for authentication to retrieve the biometric data for the user from the database. The authentication server then performs a biometric comparison of the recorded video against the biometric data for the user previously obtained, e.g., at enrollment. In some implementations, the authentication server may ask other trusted entities to perform the biometric matching on its behalf.

At 534, if the biometric comparison fails to produce a match, the request for authentication may be rejected at 535. For example, an attacker initiating a request for authentication for a user will fail the biometric matching, and thus the attacker's initiating device will not be verified as an endpoint trusted to initiate authentication requests. On the other hand, if the biometric comparison produces a match, the initiating device is verified as a trusted endpoint and the process may proceed to step 550 in which the authentication server proceeds further with the authentication process.

At 536, the video of the user may be shown to the user's peers, e.g., within an organization, on the peer's devices, to receive peer approval or rejection. For example, there may be an electronic organizational database that contains relationships between various users who are associated with an organization, comprising of an identifier for each member of the organization, along with information on their relationships to other members. The authentication server may use this database to select peers to approve the user's identity based on the relationships and which peers might know the user adequately to identify the user from sight (and optionally voice). The authentication server may then send the video to one or more peers on their electronic devices and ask the peers to electronically confirm the user's identity on their devices e.g., using buttons (virtual buttons) that allow the peers to confirm the identity of the user, deny the identity of the user, and, in some implementations, indicate the peer is unsure of the user identity.

At 537, if one or more of the peers deny the user's identity, the request for authentication may be rejected at 538. For example, an attacker initiating a request for authentication for a user will fail the peer review, and thus the attacker's initiating device will not be verified as an endpoint trusted to initiate authentication requests. On the other hand, if the peers approve the identity of the user, the initiating device is verified as a trusted endpoint and the process may proceed to step 550 in which the authentication server proceeds further with the authentication process.

At 550, the authentication server proceeds with the authentication process. For example, in some implementations, because the initiating device is verified as a trusted endpoint and the authentication attempt may be considered low risk, the authentication server may proceed with the normal authentication procedure, e.g., by sending a confirmation request to the confirming device associated with the user, e.g., similar to step 3 shown in FIG. 1. For example, a confirmation request is sent to the confirming device associated with the user, and if the user confirms the authentication request on the confirming device, then the request for authentication is accepted, and if the user rejects confirmation, then the request for authentication is rejected. In other implementations, the procedure illustrated in FIG. 5A may be combined with additional security procedures, such as the use of certificates, and the authentication server may proceed with the additional security procedures if the initiating device is verified as a trusted endpoint.

FIG. 5B illustrates an example process 500′ of using video to establish trust of an endpoint along with an additional security procedure of the use of certificates to prevent an AiTM attack on an MFA system, in accordance with some implementations. The example illustrated in FIG. 5B uses video from the initiating device to verify that the initiating device is a trusted endpoint, which may be used to issue or update certificates. In this method, the initiating device must present a valid certificate to be able to authorize the initiation of the authentication procedure. Only if a certificate is present will the authentication server send a request for confirmation to a confirming device. If a certificate is not present, then the authentication server may use the video of the user from the initiating device to determine if the initiating device is a trusted endpoint within a process of creating and sending a certificate to the initiating device. The process of detecting and verifying the certificate, and verifying the initiating device as a trusted endpoint may be implemented on the authentication server, such as server 106 shown in FIG. 1, or another computer systems acting on behalf of the authentication server. As discussed in FIG. 5A, the use of video of the user from the initiating device advantageously separates high-risk authentication attempts from low-risk authentication attempts. For example, if the authentication attempt is deemed to be low risk, but a valid certificate is missing, the certificate may be issued to the initiating device, while a high-risk authentication attempt may be rejected or referred to an administrator for assistance.

At 510, the authentication server receives a request for authentication for a user from an initiating device. For example, the receipt of a request for authentication for a user is illustrated at step 2 in FIG. 1 in which an authorized user has initiated the request and is illustrated in step 6 of FIG. 2 in which an attacker has initiated the request. When an initiating device sends the request for authentication, it will typically include an identifier for the user who is seeking authentication services, e.g., such as the user's email address, which may be used by the authentication server to look up the user within an internal database. Additionally, the request for authentication from an initiating device is expected to include a certificate in order to proceed with the authentication procedure. The certificate, for example, may be any type of a public key certificate, also known as a digital certificate or identity certificate, generated and issued by a trusted source, such as the authentication server itself or a third party that is trusted by the authentication server. A set of certificate issuers trusted by the authentication server may be configurable, e.g., according to industry standards. In some implementations, the set of certificate issuers trusted by the authentication server may be specified to the authentication server when it starts up and/or may be updated occasionally automatically by the authentication server or via administrative control.

At 520, the authentication server determines if a valid certificate is present in the request for authentication. For example, as discussed in FIG. 4A and FIG. 4B, the authentication server may determine if the initiating device presents a certificate, and if so, the authentication server decodes the information contained in the certificate. The authentication server may then determine if the certificate presented is valid. A certificate may be determined to be valid if the issuer is trusted and the certificate has not expired. In addition, the authentication server may determine if the certificate presented corresponds with one previously issued to the user who is attempting authentication. The authentication server, for example, may look up the user in an internal database and retrieve any associated certificate information which is compared to the information from the received certificate in making this determination.

At 522, in response to a valid certificate being presented, the authentication request may be deemed to be a low-risk authentication attempt and the authentication server may proceed with the normal authentication procedure, e.g., by sending a confirmation request to the confirming device associated with the user, e.g., similar to step 3 shown in FIG. 1.

At 524, if the user confirms the authentication request on the confirming device, then the request for authentication is accepted at 525. Confirmation can be effectuated by one or more of the following: a user pressing a button on the ACI, a user entering a code or password into the ACI, a user confirming via biometrics. On the other hand, if the user rejects the authentication request on the confirming device, then the request for authentication is rejected at 526.

At 527, in response to a valid certificate not being present at step 520, the authentication server may send a message to the to the user, e.g., at the initiating device, the confirming device, or both, indicating that the initiating device is not authorized. It then requests approval from the user to add a certificate to the initiating device in order to authorize the initiating device.

At 528, the authentication server determines if the user agrees to authorize the initiating device, and if not, the request for authorization is rejected at 529. In response to receiving agreement from the user to authorize the initiating device at step 528, the process may proceed to step 530, discussed in FIG. 5A, to use video of the user at the initiating device to verify whether the initiating device is a trusted endpoint.

At 550, assuming that the initiating device is verified as a trusted endpoint in step 530, the authentication server may proceed further with the authentication process. For example, as illustrated in FIG. 5B, after verifying that the initiating device is a trusted endpoint, at 552, the authentication server may generate the certificate, or acquire the certificate from a trusted third party, and send the certificate to the initiating device. The authentication server may map the user to the certificate and store that mapping in an internal database for future use. At 554, a message may be sent to the user, e.g., at the confirming device or the initiating device, instructing the user to accept the certificate and then to re-initiate an authentication attempt from the initiating device. If the user accepts the certificate, that certificate is now valid, and the next authentication attempt may be re-initiated and the authentication process proceeds accordingly, e.g., the authentication server will receive the request for authentication for the user from the initiating device, which now includes a valid certificate, as described in steps 520 and 522. Of course, if the initiating device is not verified as a trusted endpoint in step 530, step 550 is not performed and the request for authentication is rejected and a message may be sent to the user, e.g., at the confirming device or the initiating device, instructing the user to contact an administrator to assist with authentication. In some implementations, the initiating device may accept the certificate automatically on behalf of the user. In some implementations, the initiating device may retry the authentication request automatically as well.

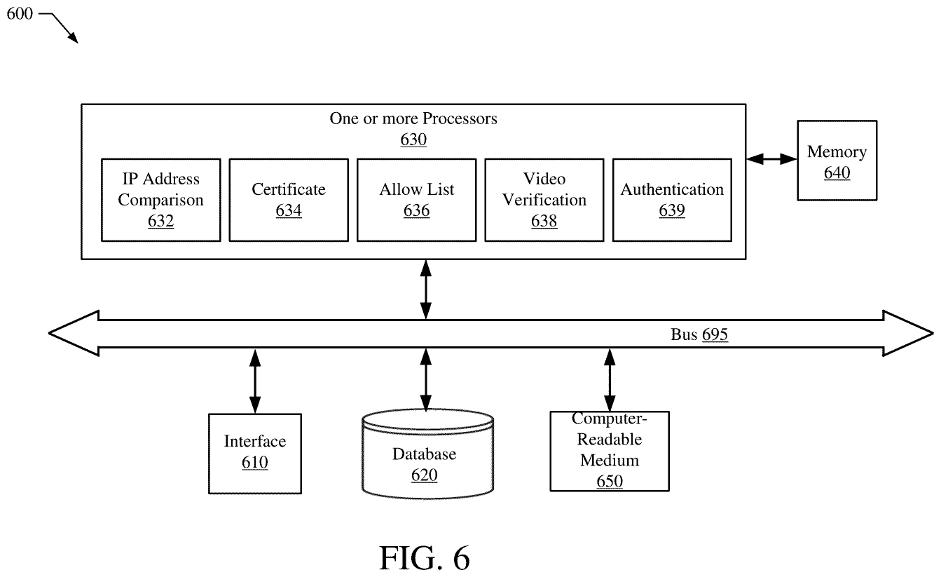

FIG. 6 illustrates an example computer system 600 that may operate as server 106 for the authentication system 100 illustrated in FIG. 1 and may be configured for verifying whether an initiating device is a trusted endpoint using, e.g., matching IP addresses or video verification to counteract AiTM type attacks and to assist in certificate deployment and management, according to implementations discussed herein. For example, the computer system 600 may be configured to verify that an initiating device for an authentication request is a trusted endpoint using matching IP addresses for the initiating device and the confirming device, and optionally using additional security procedures, such as an allow list, as discussed in FIGS. 3A and 3B. The computer system 600 may be configured to verify that an initiating device for an authentication request is a trusted endpoint using matching IP addresses for the initiating device and the confirming device to assist in certificate deployment and management, and optionally using additional security procedures, such as an allow list, as discussed in FIGS. 4A, 4B, and 4C. The computer system 600 may be configured to verify that an initiating device for an authentication request is a trusted endpoint using video verification for the initiating device, and optionally for assisting with additional security procedures, such as assisting in certificate deployment and management, as discussed in FIGS. 5A and 5B.

The computer system 600 is shown to include an interface 610, one or more databases 620, one or more processors 630, a memory 640 coupled to the one or more processors 630, and computer-readable medium 650. In some implementations, the various components of the computer system 600 may be interconnected by at least a data bus 695, which may be any known internal or external bus technology, including but not limited to ISA (Industry Standard Architecture), EISA (Extended Industry Standard Architecture), PCI (Peripheral Component Interconnect), PCI Express, NuBus, USB (Universal Serial Bus), Serial ATA (Serial Advanced Technology Attachment), or Fire Wire. In other implementations, the various components of the computer system 600 may be interconnected using other suitable signal routing resources, for example, the components may be distributed among multiple physical locations and coupled by a network connection.

The computer system 600 may communicate, via the interface 610, with multiple users via initiating devices, e.g., through the AII 104 in each initiating device 103 shown in FIG. 1, and/or confirming devices, e.g., through the ACI 108 in confirming device 107 shown in FIG. 1. The computer system 600 may further communicate with an administrator, e.g., administrator 105 shown in FIG. 1. The interface 610 may be one or more input/output (I/O) interfaces to communicate with users (such as via a web portal for a remote system or user interface devices for a local system) and administrators. An example interface 610 may include a wired interface or wireless interface to the internet or other means to communicably couple with other devices. For example, the interface 610 may include an interface with an ethernet cable or a wireless interface to a modem, which is used to communicate with an internet service provider (ISP) directing traffic to and from other devices (if computer system 600 is remote). If the computer system 600 is local, the interface 610 may include a display, a speaker, a mouse, a keyboard, or other suitable input or output elements that allow interfacing with an administrator.

The one or more database 620 may store data, including login information and biometric information for users, e.g., obtained during enrollment of each user. The one or more database 620 may additionally store IP addresses of electronic devices associated with authorized users. The one or more database 620 may additionally store data for certificates issued to electronic devices associated with authorized users. The one or more database 620 may additionally store data generated in the authentication processes as discussed herein.

The one or more processors 630 may include one or more suitable processors capable of executing scripts or instructions of one or more software programs stored in computer system 600 (such as within memory 640 and/or the computer-readable medium 650). For example, the one or more processors 630 may be capable of executing one or more of the applications. The one or more processors 630 may include a general-purpose single-chip or multi-chip processor, a digital signal processor (DSP), an application specific integrated circuit (ASIC), a field programmable gate array (FPGA) or other programmable logic device, discrete gate or transistor logic, discrete hardware components, or any combination thereof that may be configured via hardware, software, or firmware to operate as special purpose processors to perform the functions described herein. In one or more implementations, the one or more processors 630 may include a combination of computing devices (such as a combination of a DSP and a microprocessor, a plurality of microprocessors, one or more microprocessors in conjunction with a DSP core, or any other such configuration). In some implementations, particular processes and methods may be performed by circuitry that is specific to a given function.

As illustrated, the one or more processors 630 is configured to perform various operations discussed herein. For example, the one or more processors 630 may be configured to operate as any of an IP address comparison processor 632 to perform IP address acquisition and comparison operations, such as discussed in, e.g., reference to FIGS. 3A, 3B, 4A, and 4C. The one or more processors 630, for example, may be configured as the IP address comparison processor 632 to acquire the IP address associated with an initiating device that sent a request for authentication for a user to the computer system 600, e.g., received via the interface 610, and to obtain the IP address for a confirming device associated with the user, e.g., based on a look up operation in the one or more databases 620 using user information provided in the request for authentication. The IP address comparison processor 632 may be configured to compare the IP addresses to verify whether the initiating device is a trusted endpoint.

In another example, the one or more processors 630 may be configured as a certificate processor 634 to perform certificate related operations, such as discussed in FIGS. 4A, 4B, 4C, and 5B. The one or more processors 630, for example, may be configured as the certificate processor 634 to determine whether a valid certificate is present in the request for authentication to verify whether the initiating device is a trusted endpoint. The one or more processors 630, for example, may be configured as the certificate processor 634 to issue or update certificates to initiating devices in response to a determination that the initiating device is a trusted endpoint based on, e.g., IP address matching or video verification.

In another example, the one or more processors 630 may be configured as an allow list processor 636 to perform the allow list operations, such as discussed in FIGS. 3B, and 4C. The one or more processors 630, for example, may be configured as the allow list processor 636 to generate and maintain an allow list, e.g., stored in the one or more databases 620, which may be configured by a system administrator via the interface 610. The allow list processor 636 may be configured to acquire the IP address associated with an initiating device that sends a request for authentication for a user to the computer system 600, e.g., received via the interface 610. The allow list processor 636 may be configured to compare the IP addresses to the allow list to verify whether the initiating device is a trusted endpoint.

In another example, the one or more processors 630 may be configured to operate as a video verification processor 638 to perform video verification operations, such as discussed in FIGS. 5A and 5B. The one or more processors 630, for example, may be configured as the video verification processor 638 to acquire video of the user from the initiating device, e.g., via the interface 610, and determine whether the user identity is confirmed to verify whether the initiating device is a trusted endpoint. The video verification processor 638, for example, may be configured to acquire biometric data associated with the user, via the one or more databases 620, and to perform a biometric comparison between the video and the biometric data. The video verification processor 638 may additionally or alternatively be configured to select appropriate peers for the user and to send the video of the user to one or more peers and to receive confirmation or rejection of the user's identity from the one or more peers via the interface 610.

In another example, the one or more processors 630 may be configured to operate as an authentication processor 639 to perform authentication operations, such as discussed in FIGS. 3A, 3B, 4A, 4B, 4C, 5A, and 5B. The one or more processors 630, for example, may be configured as the authentication processor 639 proceed with an authentication procedure if the initiating device is verified as a trusted endpoint. If the initiating device is a trusted endpoint, for example, the authentication processor 639, for example, may be configured to obtain a confirming device associated with the user, e.g., a look up operation in the one or more databases 620, based on user information provided in the request, and to send a confirmation request and receive a response to and from the confirming device, e.g., via the interface 610, and to accept or reject the authentication accordingly. If the initiating device is not a trusted endpoint the authentication processor 639 may be configured to reject the request for authentication and to provide appropriate messaging to the user at the initiating device and/or confirming device, via the interface 610.

The memory 640 may be any memory (such as RAM, flash, etc.) that temporarily or permanently stores data, such as any number of software programs, executable instructions, machine code, algorithms, and the like that can be executed by the one or more processors 630 to perform one or more corresponding operations or functions. In some implementations, the memory 640 may be connected directly to or integrated with the one or more processors 630, e.g., as a processing in memory (PIM) chip. In some implementations, the memory 640 may be connected directly to bus 695 in addition or in alternative to being connected directly to the one or more processors 630.

Computer-readable medium 650 may be any computer-readable medium that participates in providing instructions to the one or more processors 630, directly or via memory 640, for execution, including without limitation, non-volatile storage media (e.g., optical disks, magnetic disks, flash drives, etc.), or volatile media (e.g., SDRAM, ROM, etc.). In some implementations, hardwire circuitry may be used in place of, or in combination with, software instructions to implement aspects of the disclosure. As such, implementations of the subject matter disclosed herein are not limited to any specific combination of hardware circuitry and/or software.

Computer-readable medium 650 may include various instructions, such as instructions for implementing an operating system (e.g., Mac OS®, Windows®, Linux, etc.). The operating system may be multi-user, multiprocessing, multitasking, multithreading, real-time, and the like. The operating system may perform basic tasks, including but not limited to recognizing input data from input devices via the interface 610, sending output data to devices via the interface 610, keeping track of files and directories on computer-readable medium 650, controlling peripheral devices (e.g., disk drives, printers, etc.) which can be controlled directly or through an I/O controller, and managing traffic on bus 695. Computer-readable medium 650 may further include network communications instructions to establish and maintain network connections via the interface 610 (e.g., software for implementing communication protocols, such as TCP/IP, HTTP, Ethernet, telephony, etc.).

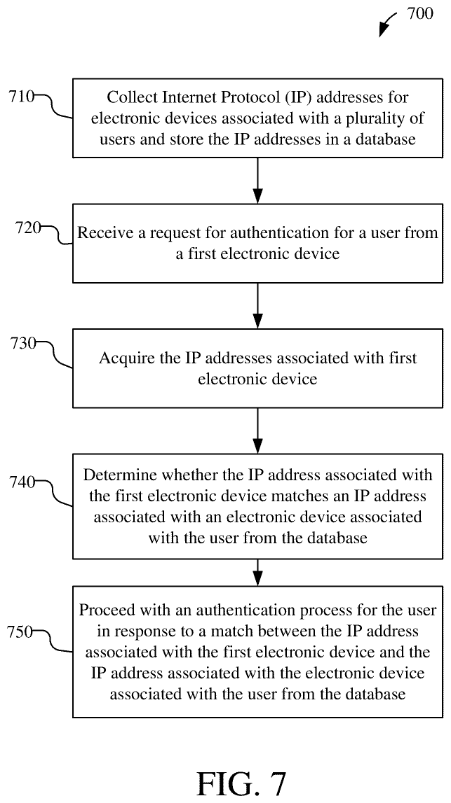

FIG. 7 is a flow chart 700 illustrating an implementation of a method of preventing an AiTM attack on deployed MFA systems. The process illustrated in flow chart 700 may be implemented on a computer system, such as on a server 106, shown in FIG. 1 that receives and handles electronically transmitted authentication requests from one or more users, e.g., via the devices associated with each respective user, such as devices 103 and 107 shown in FIG. 1. It should be understood that the process illustrated in flow chart 700 is automated on a computer system and is scalable to any number of users.

As illustrated, at 710, Internet Protocol (IP) addresses are collected for electronic devices associated with a plurality of users, and the IP addresses are stored in a database, e.g., as discussed in reference to step 310 in FIGS. 3A and 3B and step 312 in FIG. 3B and step 410 in FIGS. 4A and 4C and step 412 in FIG. 4C.

At 720, a request for authentication is received for a user from a first electronic device, e.g., as discussed in reference to step 320 in FIGS. 3A and 3B and step 420 in FIGS. 4A and 4C.

At 730, the IP addresses associated with first electronic device is acquired, e.g., as discussed in reference to step 330 in FIGS. 3A and 3B and step 450 in FIGS. 4A and 4C.

At 740, the server determines whether the IP address associated with the first electronic device matches an IP address associated with an electronic device associated with the user from the database, e.g., as discussed in reference to step 350 in FIGS. 3A and 3B and step 460 in FIGS. 4A and 4C.

At 750, the server proceeds with an authentication process for the user in response to a match between the IP address associated with the first electronic device and the IP address associated with the electronic device associated with the user from the database, e.g., as discussed in reference to steps 360, 370, and 372 in FIGS. 3A and 3B and steps 470, 472, 476, and 478 in FIGS. 4A and 4C. In some implementations, the server may further reject the request for authentication in response to a mismatch between the IP address associated with the first electronic device and the IP address associated with the electronic device associated with the user from the database, e.g., as discussed in reference to steps 360, 370, and 374 in FIGS. 3A and 3B and steps 460 and 480 in FIGS. 4A and 4C.

In some implementations, the method may further include generating an allow list based on the IP addresses associated with the plurality of users, e.g., as discussed in reference to step 314 in FIG. 3B and step 414 in FIG. 4C. The server further determines whether the IP address associated with first electronic device is on the allow list, e.g., as discussed in reference to step 340 in FIG. 3B and step 458 in FIG. 4C. The server proceeds with authentication for the user in response to a determination that the IP address associated with the first electronic device is on the allow list, e.g., as discussed in reference to steps 360, 370, and 372 in FIG. 3B and step 470 in FIG. 4C. For example, the server may determine whether the IP address associated with the first electronic device matches the IP address associated with an electronic device associated with the user from the database in response to a determination that the IP address associated with the first electronic device is not on the allow list, e.g., as discussed in reference to steps 340 and 350 in FIG. 3B and steps 458 and 460 in FIG. 4C. In some implementations, the allow list is configurable by system administration, e.g., as discussed in reference to step 314 in FIG. 3B and step 414 in FIG. 4C.

In some implementations, the method may further include the server determining whether a certificate is present in the request for authentication, e.g., as discussed in reference to step 430 in FIGS. 4A and 4C. The server proceeds with the authentication process for the user in response to a determination that the certificate is present in the request for authentication, e.g., as discussed in reference to steps 440, 442, 444, and 446 in FIGS. 4A and 4C. The server authenticates the user and uploads a certificate to the first electronic device in response to a determination that the certificate is not present in the request for authentication, e.g., as discussed in reference to steps 430, 450, 460, 470, 472, 476 in FIGS. 4A and 4C.

In some implementations, authenticating the user may include sending a request for authorization of the first electronic device to the electronic device associated with the user from the database, e.g., as discussed in reference to step 440 in FIG. 4A. The server may reject the request for authentication in response to a rejection of the request for authorization from the user via electronic device associated with the user, e.g., as discussed in reference to steps 442 and 446 in FIG. 4A. In some implementations, authenticating the user may include the determining whether the IP address associated with the first electronic device matches the IP address associated with the electronic device associated with the user from the database, e.g., as discussed in reference to step 460 in FIG. 4A. For example, the server may authenticate the user by sending a request to add a certificate to the first electronic device to the electronic device associated with the user from the database in response to the match between the IP address associated with the first electronic device and the IP address associated with the electronic device associated with the user from the database, e.g., as discussed in reference to steps 460 and 470 in FIG. 4A, and by sending the certificate to the first electronic device in response to receiving acceptance of the request to add the certificate to the first electronic device, e.g., as discussed in reference to steps 472 and 476 in FIG. 4A. In some implementations, the server may further send an instruction to the user via the electronic device associated with the user to reinitiate the request for authentication for the user on the first electronic device after the certificate is sent to the first electronic device, e.g., as discussed in reference to steps 478 in FIG. 4A. The server may reject the request for authentication in response to a rejection of the request to add the certificate to the first electronic device, e.g., as discussed in reference to steps 472 and 474 in FIG. 4A.

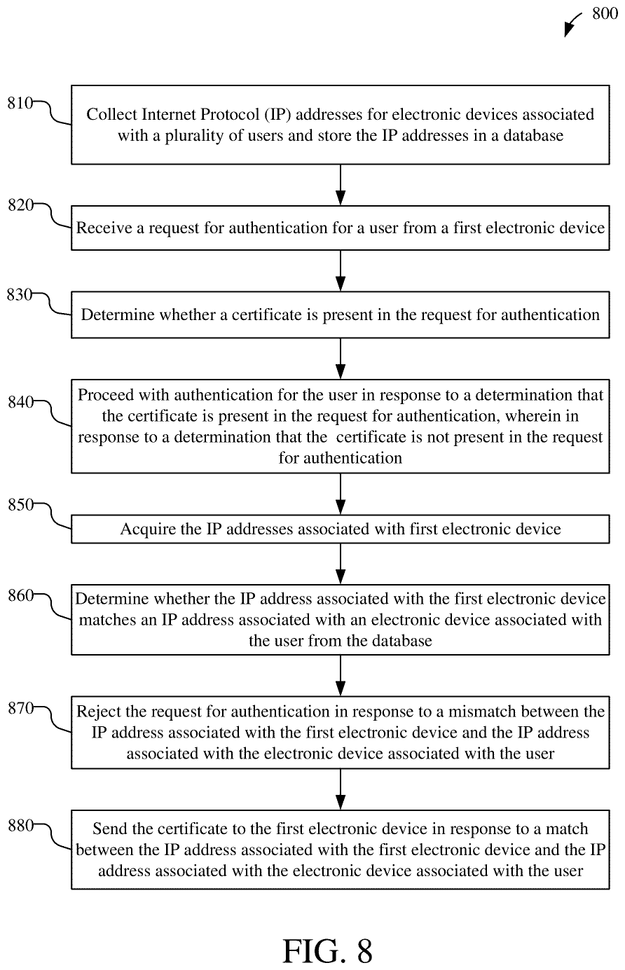

FIG. 8 is a flow chart 800 illustrating an implementation of a method of preventing an AiTM attack on deployed MFA systems. The process illustrated in flow chart 800 may be implemented on a computer system, such as on a server 106, shown in FIG. 1 that receives and handles electronically transmitted authentication requests from one or more users, e.g., via the devices associated with each respective user, such as devices 103 and 107 shown in FIG. 1. It should be understood that the process illustrated in flow chart 800 is automated on a computer system and is scalable to any number of users.

As illustrated, at 810, Internet Protocol (IP) addresses are collected for electronic devices associated with a plurality of users, and the IP addresses are stored in a database, e.g., as discussed in reference to step 410 in FIGS. 4A and 4C and step 412 in FIG. 4C.

At 820, a request for authentication is received for a user from a first electronic device, e.g., as discussed in reference to step 420 in FIGS. 4A and 4C.

At 830, the server determines whether a certificate is present in the request for authentication, e.g., as discussed in reference to step 430 in FIGS. 4A and 4C.

At 840, the server proceeds with authentication for the user in response to a determination that the certificate is present in the request for authentication, e.g., as discussed in reference to steps 440, 442, 444, and 446 in FIGS. 4A and 4C.

In response to a determination that the certificate is not present in the request for authentication, the method proceeds to 850, at which the server acquires the IP addresses associated with first electronic device is acquired, e.g., as discussed in reference to step 450 in FIGS. 4A and 4C.

At 860, the server determines whether the IP address associated with the first electronic device matches an IP address associated with an electronic device associated with the user from the database, e.g., as discussed in reference to step 460 in FIGS. 4A and 4C.

At 870, the server rejects the request for authentication in response to a mismatch between the IP address associated with the first electronic device and the IP address associated with the electronic device associated with the user, e.g., as discussed in reference to steps 460 and 480 in FIGS. 4A and 4C.

At 880, the server sends the certificate to the first electronic device in response to a match between the IP address associated with the first electronic device and the IP address associated with the electronic device associated with the user, e.g., as discussed in reference to steps 460, 470, 472, 476 in FIGS. 4A and 4C.

In some implementations, the server may send a request to add a certificate to the first electronic device to the electronic device associated with the user from the database in response to the match between the IP address associated with the first electronic device and the IP address associated with the electronic device associated with the user, wherein the certificate is sent to the first electronic device further in response to receiving an acceptance of the request to add the certificate to the Authentication Initiation Interface, e.g., as discussed in reference to steps 460, 470, 472, 476 in FIGS. 4A and 4C. The server may reject the request for authentication in response to a rejection of the request to add the certificate to the first electronic device, e.g., as discussed in reference to steps 470, 472, 474 in FIGS. 4A and 4C.

In some implementations, the server may an instruction to the user via the electronic device associated with the user to reinitiate the request for authentication for the user on the first electronic device after the certificate is sent to the first electronic device, e.g., as discussed in reference to steps 478 in FIG. 4A.

In some implementations, in response to a determination that the certificate is present in the request for authentication, the server may determine whether the certificate is valid, and the server proceeds with the authentication for the user is further in response to a determination that the certificate is valid, e.g., as discussed in reference to steps 436 and 440 in FIG. 4B. Additionally, in response to a determination that the certificate is not valid, server determines whether the IP address associated with the first electronic device matches the IP address associated with an electronic device associated with the user from the database, e.g., as discussed in reference to steps 436 and 450 in FIGS. 4A and 4B. The server rejects the request for authentication in response to a mismatch between the IP address associated with the first electronic device and the IP address associated with the electronic device associated with the user, e.g., as discussed in reference to steps 460 and 480 in FIG. 4A, and sends the certificate to the first electronic device in response a match between the IP address associated with the first electronic device and the IP address associated with the electronic device associated with the user, e.g., as discussed in reference to steps 460 and 476 in FIG. 4A.

In some implementations, in response to the determination that the certificate is not present in the request for authentication, the server sends a request to add the certificate to the first electronic device to the first electronic device to the electronic device associated with the user, e.g., as discussed in reference to steps 430 and 452 in FIG. 4C. The server rejects the request for authentication in response to a rejection of the request to add the certificate to the first electronic device rejection of the request for approval to authorize the first electronic device, e.g., as discussed in reference to steps 454 and 456 in FIG. 4C. The server determines whether the IP address associated with the first electronic device matches the IP address associated with an electronic device associated with the user from the database in response to an acceptance of the request for approval to authorize the first electronic device, e.g., as discussed in reference to steps 454 and 470 in FIG. 4C.

In some implementations, the method may further include generating an allow list based on the IP addresses associated with the plurality of users, e.g., as discussed in reference to step 414 in FIG. 4C. In response to a determination that the certificate is not present in the request for authentication, the server may determine whether the IP address associated with first electronic device is on the allow list, e.g., as discussed in reference to steps 430 and 458 in FIG. 4C. The server sends the certificate to the first electronic device in response to a determination that the IP address associated with the first electronic device is on the allow list, e.g., as discussed in reference to steps 430, 458, 470, 472, and 476 in FIGS. 4A and 4C. The server determines whether the IP address associated with the first electronic device matches the IP address associated with an electronic device associated with the user from the database in response to a determination that the IP address associated with the first electronic device is not on the allow list, e.g., as discussed in reference to steps 458 and 460 in FIGS. 4A and 4C. In some implementations, the allow list is configurable by system administration, e.g., as discussed in reference to step 414 in FIG. 4C. In some implementations, in response to the determination that the IP address associated with the first electronic device is on the allow list, the server may send a request to add a certificate to the first electronic device to the electronic device associated with the user from the database in response, where the certificate is sent to the first electronic device in response to receiving an acceptance of the request to add the certificate, e.g., as discussed in reference to steps 458, 470, 472, and 476 in FIGS. 4A and 4C, and the server rejects the request for authentication in response to a rejection of the request to add the certificate to the first electronic device, e.g., as discussed in reference to steps 458, 470, 472, and 474 in FIGS. 4A and 4C.

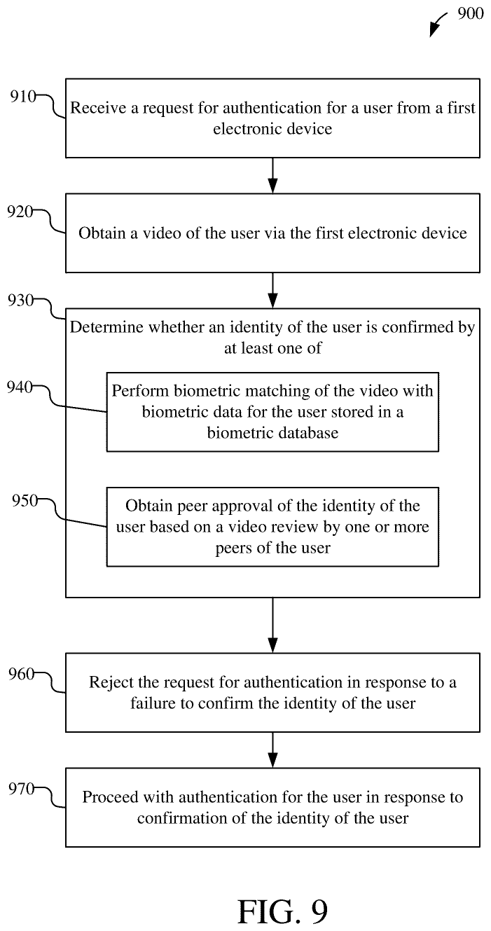

FIG. 9 is a flow chart 900 illustrating an implementation of a method of preventing an AiTM attack on deployed MFA systems. The process illustrated in flow chart 900 may be implemented on a computer system, such as on a server 106, shown in FIG. 1 that receives and handles electronically transmitted authentication requests from one or more users, e.g., via the devices associated with each respective user, such as devices 103 and 107 shown in FIG. 1. It should be understood that the process illustrated in flow chart 900 is automated on a computer system and is scalable to any number of users.

As illustrated, at 910, a request for authentication is received for a user from a first electronic device, e.g., as discussed in reference to step 510 in FIGS. 5A and 5B.

At 920, a video of the user is obtained via the first electronic device, e.g., as discussed in reference to steps 530 and 531 in FIGS. 5A and 5B.

At 930, the server determines whether an identity of the user is confirmed, e.g., as discussed in reference to step 530 in FIGS. 5A and 5B. The identity of the user may be confirmed by at least one of the server performing biometric matching of the video with biometric data for the user stored in a biometric database at 940, e.g., as discussed in reference to step 533 in FIG. 5A, or obtaining peer approval of the identity of the user based on a video review by one or more peers of the user and 950, e.g., as discussed in reference to step 536 and 537 in FIG. 5A.

At 960, the server rejects the request for authentication in response to a failure to confirm the identity of the user, e.g., as discussed in reference to steps 535 and 538 in FIG. 5A.

At 970, the server proceeds with authentication for the user in response to confirmation of the identity of the user, e.g., as discussed in reference to steps 530, 534, 537, 550 in FIGS. 5A and 5B.

In some implementations, the server may additionally determine whether a certificate is present in the request for authentication, e.g., as discussed in reference to step 520 in FIG. 5B. The server proceeds with authentication for the user in response to a determination that the certificate is present in the request for authentication, e.g., as discussed in reference to step 520, 522, 524, 525 and 526 in FIG. 5B. In response to a determination that the certificate is not present in the request for authentication, the video of the user is obtained via the first electronic device and the server determines whether the identity of the user is confirmed, e.g., as discussed in reference to step 520 and 530 in FIGS. 5A and 5B. For example, in response to the determination that the certificate is present in the request for authentication, the server may determine whether the certificate is valid, and the server may proceed with the authentication for the user in response to a determination that the certificate is valid, e.g., as discussed in reference to step 520 in FIG. 5B. In response to a determination that the certificate is not valid, the server may obtain the video of the user via the first electronic device and determine whether the identity of the user is confirmed.

In some implementations, the server proceeds with the authentication for the user by sending an instruction to the user via the electronic device associated with the user to reinitiate the request for authentication for the user on the first electronic device after the certificate is sent to the first electronic device, e.g., as discussed in reference to steps 554 in FIG. 5B.

In some implementations, in response to the determination that the certificate is not present in the request for authentication, the server may send a request to add the certificate to the first electronic device to the electronic device associated with the user, e.g., as discussed in reference to steps 520 and 527 in FIG. 5B. The server obtains the video of the user via the first electronic device and determines whether the identity of the user is confirmed in response to an acceptance of the request to add the certificate to the first electronic device, e.g., as discussed in reference to steps 528 and 530 in FIG. 5B. In some implementations, the server may reject the request for authentication in response to a rejection of the request to add the certificate to the first electronic device, e.g., as discussed in reference to steps 528 and 529 in FIG. 5B. In some implementations, the server may perform IP address matching in response to a rejection of the request to add the certificate to the first electronic device, e.g., as discussed in reference to steps 528 and 529 in FIG. 5B and discussed in, e.g., FIG. 3A and FIG. 7.

Those skilled in the art will understand that the preceding implementations of the present disclosure provide the foundation for numerous alternatives and modifications that are also deemed within the scope of the present disclosure. The above description is intended to be illustrative, and not restrictive. For example, the above-described examples (or one or more aspects thereof) may be used in combination with each other. Other implementations can be used, such as by one of ordinary skill in the art upon reviewing the above description. Also, various features may be grouped together and less than all features of a particular disclosed implementation may be used. Thus, the following aspects are hereby incorporated into the above description as examples or implementations, with each aspect standing on its own as a separate implementation, and it is contemplated that such implementations can be combined with each other in various combinations or permutations. Therefore, the spirit and scope of the appended claims should not be limited to the foregoing description.

What is claimed is:

1. A method for preventing an Adversary in the Middle (AiTM) attack on deployed Multi-Factor Authentication (MFA) system, the method comprising:
collecting Internet Protocol (IP) addresses for electronic devices associated with a plurality of users and store the IP addresses in a database;
receiving a request for authentication for a user from a first electronic device;
acquiring the IP addresses associated with first electronic device;
determining whether the IP address associated with the first electronic device matches an IP address associated with an electronic device associated with the user from the database; and
proceeding with an authentication process for the user in response to a match between the IP address associated with the first electronic device and the IP address associated with the electronic device associated with the user from the database.

2. The method of claim 1, further comprising rejecting the request for authentication in response to a mismatch between the IP address associated with the first electronic device and the IP address associated with the electronic device associated with the user from the database.

3. The method of claim 1, further comprising:
generating an allow list based on the IP addresses associated with the plurality of users;
determining whether the IP address associated with first electronic device is on the allow list; and
proceeding with authentication for the user in response to a determination that the IP address associated with the first electronic device is on the allow list.

4. The method of claim 3, wherein determining whether the IP address associated with the first electronic device matches the IP address associated with an electronic device associated with the user from the database is performed in response to a determination that the IP address associated with the first electronic device is not on the allow list.

5. The method of claim 3, wherein the allow list is configurable by system administration.

6. The method of claim 1, further comprising:
determining whether a certificate is present in the request for authentication;
proceeding with the authentication process for the user in response to a determination that the certificate is present in the request for authentication; and
authenticating the user and uploading a certificate to the first electronic device in response to a determination that the certificate is not present in the request for authentication.

7. The method of claim 6, wherein authenticating the user comprises sending a request for authorization of the first electronic device to the electronic device associated with the user from the database.

8. The method of claim 7, further comprising rejecting the request for authentication in response to a rejection of the request for authorization from the user via electronic device associated with the user.

9. The method of claim 6, wherein authenticating the user comprises the determining whether the IP address associated with the first electronic device matches the IP address associated with the electronic device associated with the user from the database.

10. The method of claim 9, wherein authenticating the user comprises:
sending a request to add a certificate to the first electronic device to the electronic device associated with the user from the database in response to the match between the IP address associated with the first electronic device and the IP address associated with the electronic device associated with the user from the database; and
sending the certificate to the first electronic device in response to receiving acceptance of the request to add the certificate to the first electronic device.

11. The method of claim 10, further comprising sending an instruction to the user via the electronic device associated with the user to reinitiate the request for authentication for the user on the first electronic device after the certificate is sent to the first electronic device.

12. The method of claim 10, further comprising rejecting the request for authentication in response to a rejection of the request to add the certificate to the first electronic device.

13. An authentication server for preventing an Adversary in the Middle (AiTM) attack on deployed Multi-Factor Authentication (MFA) system, comprising:
at least one memory; and
a processing system comprising one or more processors coupled to the at least one memory, the processing system configured to:
collect Internet Protocol (IP) addresses for electronic devices associated with a plurality of users and store the IP addresses in a database;
receive a request for authentication for a user from a first electronic device;
acquire the IP addresses associated with first electronic device;
determine whether the IP address associated with the first electronic device matches an IP address associated with an electronic device associated with the user from the database; and
proceed with an authentication process for the user in response to a match between the IP address associated with the first electronic device and the IP address associated with the electronic device associated with the user from the database.

14. A method for preventing an Adversary in the Middle (AiTM) attack on deployed Multi-Factor Authentication (MFA) system, the method comprising:
collecting Internet Protocol (IP) addresses for electronic devices associated with a plurality of users and store the IP addresses in a database;
receiving a request for authentication for a user from a first electronic device;
determining whether a certificate is present in the request for authentication; and
proceeding with authentication for the user in response to a determination that the certificate is present in the request for authentication, wherein in response to a determination that the certificate is not present in the request for authentication the method further comprises:
acquiring the IP addresses associated with first electronic device;
determining whether the IP address associated with the first electronic device matches an IP address associated with an electronic device associated with the user from the database;
rejecting the request for authentication in response to a mismatch between the IP address associated with the first electronic device and the IP address associated with the electronic device associated with the user; and
sending the certificate to the first electronic device in response to a match between the IP address associated with the first electronic device and the IP address associated with the electronic device associated with the user.

15. The method of claim 14, further comprising:
sending a request to add a certificate to the first electronic device to the electronic device associated with the user from the database in response to the match between the IP address associated with the first electronic device and the IP address associated with the electronic device associated with the user, wherein the certificate is sent to the first electronic device further in response to receiving an acceptance of the request to add the certificate to the first electronic device; and
rejecting the request for authentication in response to a rejection of the request to add the certificate to the first electronic device.

16. The method of claim 14, further comprising sending an instruction to the user via the electronic device associated with the user to reinitiate the request for authentication for the user on the first electronic device after the certificate is sent to the first electronic device.

17. The method of claim 14, wherein in response to a determination that the certificate is present in the request for authentication, the method further comprises:
determining whether the certificate is valid, and wherein proceeding with the authentication for the user is further in response to a determination that the certificate is valid;
wherein in response to a determination that the certificate is not valid, the method further comprises:
determining whether the IP address associated with the first electronic device matches the IP address associated with an electronic device associated with the user from the database;
rejecting the request for authentication in response to a mismatch between the IP address associated with the first electronic device and the IP address associated with the electronic device associated with the user; and
sending the certificate to the first electronic device in response a match between the IP address associated with the first electronic device and the IP address associated with the electronic device associated with the user.

18. The method of claim 14, wherein in response to the determination that the certificate is not present in the request for authentication, the method further comprises:
sending a request for approval to authorize the first electronic device to receive a certificate to the electronic device associated with the user; and
rejecting the request for authentication in response to a rejection of the request for approval to authorize the first electronic device;
wherein the determining whether the IP address associated with the first electronic device matches the IP address associated with an electronic device associated with the user from the database is in response to an acceptance of the request for approval to authorize the first electronic device.

19. The method of claim 14, further comprising:
generating an allow list based on the IP addresses associated with the plurality of users;
wherein in response to a determination that the certificate is not present in the request for authentication the method further comprises:
determining whether the IP address associated with first electronic device is on the allow list; and
sending the certificate to the first electronic device in response to a determination that the IP address associated with the first electronic device is on the allow list.

20. The method of claim 19, wherein determining whether the IP address associated with the first electronic device matches the IP address associated with an electronic device associated with the user from the database is performed in response to a determination that the IP address associated with the first electronic device is not on the allow list.

21. The method of claim 19, wherein in response to the determination that the IP address associated with the first electronic device is on the allow list, the method further comprises:
sending a request to add a certificate to the first electronic device to the electronic device associated with the user from the database in response, wherein the certificate is sent to the first electronic device in response to receiving an acceptance of the request to add the certificate; and
rejecting the request for authentication in response to a rejection of the request to add the certificate to the first electronic device.

22. The method of claim 19, wherein the allow list is configurable by system administration.

23. An authentication server for preventing an Adversary in the Middle (AiTM) attack on deployed Multi-Factor Authentication (MFA) system, comprising:
at least one memory; and
a processing system comprising one or more processors coupled to the at least one memory, the processing system configured to:
collect Internet Protocol (IP) addresses for electronic devices associated with a plurality of users and store the IP addresses in a database;
receive a request for authentication for a user from a first electronic device;
determine whether a certificate is present in the request for authentication; and
proceed with authentication for the user in response to a determination that the certificate is present in the request for authentication, wherein in response to a determination that the certificate is not present in the request for authentication the processing system is further configured to:
acquire the IP addresses associated with first electronic device;
determine whether the IP address associated with the first electronic device matches an IP address associated with an electronic device associated with the user from the database;
reject the request for authentication in response to a mismatch between the IP address associated with the first electronic device and the IP address associated with the electronic device associated with the user; and
send the certificate to the first electronic device in response to a match between the IP address associated with the first electronic device and the IP address associated with the electronic device associated with the user.
